(19) United States
(12) Patent Application Publication
(10) Pub. No.: US 2007/0251260 A1
(43) Pub. Date: Nov. 1, 2007

(54) Systems and methods for dispensing product

(76) Inventors: James R. Baxter, Taunton, MA (US); Steven A. Lowe, Canterbury, NH (US)

Correspondence Address: MINTZ, LEVIN, COHN, FERRIS, GLOVSKY;AND POPEO, P.C., ONE FINANCIAL CENTER, BOSTON, MA, 02111, US

(21) Appl. No.: 11/333,829

(22) Filed: Jan. 17, 2006

Related U.S. Application Data
(60) Provisional application No. 60/644,258, filed on Jan. 14, 2005.

(51) Int. Cl. A23G 9/00

(52) U.S. Cl. 62/342; 222/144.5; 62/340

(57) ABSTRACT

An apparatus for producing a food product includes a frame, a first module coupled to the frame and operative to provide a first food product, a second module coupled to the frame and operative to provide a second food product, a selection assembly coupled to the frame and having an outlet and a plurality of inlets, each inlet operative to receive a portion of the second food product, the selection assembly operative to allow passage of the portion of the second food assembly from an inlet to the outlet, a tube kit having a proximal end including a first opening coupled to the first module and a second opening for receiving air, the tube kit having a distal end coupled to the outlet of the selection assembly, the tube kit operative to combine the first food product, air and the portion of the second food product to produce a product mix, and a food preparation assembly coupled to the frame and adapted to receive the product mix from the distal end of the tube kit and to prepare food from the product mix.

### RELATED APPLICATIONS

This application claims priority to U.S. Provisional Application No. 60/644,258, filed Jan. 14, 2005 and entitled, “Systems and Methods for Dispensing Products,” which is herein incorporated by reference.

### BACKGROUND OF THE INVENTION

Aerated frozen food products generally require mixing of selected liquid ingredients with a prescribed volume of air and freezing of the resultant mixture and dispensing of the finished product. The desirability of the finished product is often related directly to the manner in which, and to the degree to which, the air is metered and blended with the liquid ingredients of the mixture, referred to as overrun, and the manner in which the blended mix is frozen and then dispensed. The prior art includes many examples of machines that dispense ice cream and other semi-frozen dairy products such as soft ice cream and frozen yogurt.

Conventionally, such machines are usually dedicated to dispensing one or two flavors of product and, in some cases, a combination of the two. For example, in an ice cream shop, there may be one machine with two separate freezing chambers for making and dispensing chocolate and vanilla ice cream, a second two-chamber machine for making and dispensing strawberry and banana ice cream, a third machine dedicated to making and dispensing coffee and frozen pudding flavors, and so on. The reason for this is that each chamber typically contains a volume of ice cream greater than is required for a single serving. In order to dispense a different flavor ice cream, that chamber must be emptied and cleaned before the new flavor can be made in that chamber and appear at the outlet of the dispenser. Additionally, the vat of pre-flavored mix from which the frozen product is made must also be clean enough to at least meet applicable health regulations. While high volume ice cream shops and confectionery stores be able to accommodate several dispensing machines dispensing many different products and flavors, smaller sales outlets can usually only accommodate one or two such machines and are thus restricted in the number of flavors that they can offer to customers.

Further, because the product is typically formed in a quantity that is greater than that to be dispensed at any one serving, the excess product remains in the chamber after formation and until additional servings draw it down. The excess is thus subjected to further freezing which promotes crystallization. Because of the relatively large quantity of the premixed flavors, and the continuous freezing of several quarts of the product, the freshness and palatability of the product may be adversely affected in outlets with relatively slow sales of the product.

Another disadvantage of many prior dispensers is that they have multiple interior surfaces and moving parts that are difficult and time consuming to clean and maintain at the end of each day or at intervals prescribed by local Health Department regulations. Each dispenser must be purged of any remaining product, and it's chamber walls, pumps and other internal parts cleaned thoroughly to prevent growth of bacteria that could otherwise contaminate the product being delivered by the dispenser. Not only is the cleaning operation expensive in terms of down time, it is also costly in terms of product waste. Furthermore, it can be an unpleasant task that is difficult to get employees to do properly.

While machines that dispense ice cream exist in the prior art, until now no way has been found to provide a single machine capable of efficiently and economically making and dispensing different frozen food confections in a wide variety of flavors and in different formats, e.g., as a cup or cone.

### SUMMARY OF THE INVENTION

The present invention relates to systems and methods for producing and dispensing aerated and/or blended products, such as food products. In general, in an aspect, the invention provides apparatus for producing a food product. The apparatus includes: a frame; a base mix module coupled to the frame and operative to provide base mix, the base mix module having a dedicated base mix module sub-controller adapted to operate the base mix module; a flavor module coupled to the frame and operative to provide flavoring, the flavor module having a dedicated flavor module sub-controller adapted to operate the flavor module; a flavor selection assembly coupled to the frame and having an outlet and a plurality of flavoring inlets, each inlet operative to receive a flavoring, the flavor selection assembly operative to allow passage of a flavoring from an inlet to the outlet, the flavor selection assembly having a flavor selection assembly sub-controller adapted to operate the flavor selection assembly; a tube kit having a proximal end including a first opening coupled to the base mix module and a second opening for receiving air, the tube kit having a distal end coupled to the outlet of the flavor selection assembly, the tube kit operative to combine base mix, air and flavoring to produce a flavored, aerated mix; a food preparation assembly coupled to the frame and adapted to receive the flavored, aerated mix from the distal end of the tube kit and to prepare food from the flavored aerated mix, the food preparation assembly having a dedicated food preparation assembly sub-controller adapted to operate the food preparation assembly; and an apparatus controller in communication with the base mix module sub-controller, the flavor module sub-controller, the flavor selection assembly sub-controller, and the food preparation assembly sub-controller and operative to provide instructions to the sub-controllers so as to operate the apparatus.

In general, in another aspect, the invention provides a base mix module including: a base mix holding bay; a tube assembly having a proximal end and a distal end, the proximal end being coupled to the base mix holding bay; a pump coupled to the tube assembly; a source of compressed air coupled to the tube assembly, the source of compressed air having an air control valve operative to control the amount of air provided to the tube assembly; and a base mix module sub-controller coupled to the pump and operative to control the pump and the air control valve so that when base mix is loaded into the base mix holding bay the base mix module sub-controller controls the amount of base mix and the amount of air injected into the tube assembly.

In general, in another aspect, the invention provides a flavor module including: a plurality of flavor packet holding bays operative to hold flavor packets; a plurality of positive displacement pumps coupled to the plurality of holding bays and operative to receive flavoring from flavor packets held in the holding bays; a plurality of electrical solenoids coupled to a slidable support plate, each solenoid operative to engage with an associated displacement pump to cause the displacement pump to dispense flavoring; a linear drive motor, the linear drive coupled to the slidable support plate; and a flavor module sub-controller in communication with each of the solenoids and the linear drive motor, the sub-controller operative to control each of the solenoids and the linear drive motor so as to select and energize a solenoid and to operate the linear drive motor to drive the slidable support plate moving the solenoids relative to the displacement pumps such that the energized solenoid causes an associated displacement pump to dispense flavoring.

In general, in another aspect, the invention provides a mix-ins/dried goods module including a plurality of mix-in assemblies. Each assembly includes an auger block forming: a storage bottle hole adapted to receive a mix-in storage bottle; an auger passage connected to the bottle hole; and a dispensing hole connected to the auger passage. Each assembly further includes an auger adapted to sit in the auger passage of the auger block, the auger having an engagable end. The mix-ins/dried goods module further includes: a plurality of drive assemblies coupled to the engagable end of the augers and operative to drive the augers; a trough assembly having a collection slot and a dispensing opening, the collection slot being coupled to the dispensing holes of the plurality of mix-in assemblies, the trough assembly operative to receive mix-ins from the mix-in assemblies and to dispense the mix-ins; and a mix-ins module sub-controller in communication with each of the drive assemblies, the sub-controller operative to control the drive assemblies so that when mix-ins bottles are loaded into the mix-ins module the sub-controller drives the engagable ends to turn the augers to dispense mix-ins.

In general, in another aspect, the invention provides a food zone apparatus for enclosing at least a portion of a substantially horizontal, flat rotary surface. The apparatus includes: a cover operative to substantially enclose at least a portion of the flat rotary surface to create a food zone; a final mixing tube interface coupled to the cover and operative to receive liquid product mix via a final mixing tube and to deposit a selected amount of liquid product mix on the rotary surface while the rotary surface is rotating so that the liquid product mix spreads out on the rotary surface and sets to form a thin, at least partially solidified product body; a scraper coupled to the cover and supported above the rotary surface, the scraper having a working edge engaging the rotary surface while said rotary surface is rotating to scrap the at least partially solidified product body into a ridge row on the rotary; a level coupled to the cover and spaced above the rotary surface to establish a gap, the level being positioned ahead of the scraper so as to level the liquid product mix to a specified height on the rotary surface while the rotary surface is rotating prior to the formation of the at least partially solidified product; a rack and pinion structure coupled to the cover, the rack and pinion structure having a rack and pinion; a plow coupled to the rack and pinion structure and operative to scrape the ridge row from the rotary surface as food product; a forming cylinder coupled to the cover and operative to receive the food product from the plow; a diaphragm resting inside the forming cylinder operative to form the food product into a scoop; a packing/cleaning plate rotatably coupled to the food cover via a packing plate shaft, the packing plate positioned under the forming cylinder to provide a food product-packing surface and to clean the forming cylinder between cleanings; a level pneumatic piston interface coupled to the level and operative to interface with at least one pneumatic piston to allow control of the level; a pinion pneumatic piston interface coupled to the cover and to the pinion drive and operative to interface with a pneumatic piston, the piston rotated by a motor to cause rotation of the pinion; a diaphragm pneumatic piston interface coupled to the diaphragm and operative to interface with a pneumatic piston to allow control of the diaphragm to form the food product; a packing plate pneumatic piston interface coupled to packing plate shaft and operative to interface with a pneumatic piston, the piston rotated by a motor to allow positioning of the packing plate; and a plurality of features in the cover operative to interface with pneumatic pistons to hold the cover against the rotating surface.

In one embodiment, the level is a squeegee. In one embodiment the specified height is between about 5/1000ths and 30/1000ths of an inch.

Yet another embodiment of the invention provides a process box including: an electrically operated pneumatic solenoid bank having an air input and a plurality of air outputs; a plurality of pneumatically driven piston assemblies, each assembly having a piston coupled to a pneumatic cylinder, each pneumatic cylinder coupled to an air output of the solenoid bank, the solenoid bank operative to control air pressure in each pneumatic cylinder, each piston adapted to interact with an associated piston interface on a food zone cover; and an air compressor coupled to the air input of the solenoid bank and operative to provide compressed air to the air input of the solenoid bank so that the solenoid bank can manage operation of the piston assemblies to control interaction of the pistons with associated piston interfaces on a food zone cover.

In general, in another aspect, the invention provides apparatus for preparing food including a food surface assembly having a central axis and a periphery. The assembly includes: an upper freeze plate having a first face and a second face, the first face forming a non-stick rotary freezing surface, which readily releases food products at low temperatures, second face having a refrigerant channel operative to pass refrigerant; a gasket adapted to couple to the freeze plate and operative to reduce cross flow of refrigerant; a lower freeze plate adapted to couple to the upper freeze plate and having a first face and a second face, the first face operative to seal the refrigerant channel leaving the refrigerant channel with an entrance hole and an exit hole; and an insulation plate adapted to couple to the lower freeze plate and operative to provide insulation to the food surface assembly.

Implementations of the invention may include one or more of the following features. The apparatus may further include: a drive shaft coupled to the food surface assembly; a drive motor coupled to the drive shaft and operative to rotate the drive shaft causing rotation of the rotary surface about the central axis; and a sub-controller coupled to the drive motor and operative to control the drive motor to control the rate of rotation of the food surface assembly.

Still another embodiment of the invention provides a refrigeration system including: a compressor having an inlet and an outlet, the outlet providing compressed refrigerant; a compressor discharge line attached to the compressor outlet; a condenser having an inlet coupled to the discharge line; a liquid gas separator having first and second inlets and first and second outlets, the first inlet adapted to receive liquid refrigerant from the condenser, the first outlet coupled to the inlet of the compressor; a liquid stepper having an inlet and an outlet, the inlet coupled to the second outlet of the liquid gas separator; a freeze table having an inlet and a outlet, the inlet coupled to the outlet of the liquid stepper; a table discharge line attached to the table outlet and to the second inlet of the liquid gas separator; a pressure sensor coupled to the table discharge line and operative to provide a pressure signal representative of the pressure in the table discharge line; a thermistor coupled to the table discharge line and operative to provide a temperature signal representative of the thermistor's temperature; a hot gas stepper coupled to the table discharge line and to the compressor discharge line; and a sub-controller in communication with the liquid stepper, the pressure transducer, the thermistor, and the hot gas stepper, the sub-controller operative to receive a pressure signal from the pressure sensor and a temperature signal from the thermistor and to control at least one of the liquid stepper and the hot gas stepper.

### BRIEF DESCRIPTION OF THE ILLUSTRATED EMBODIMENTS

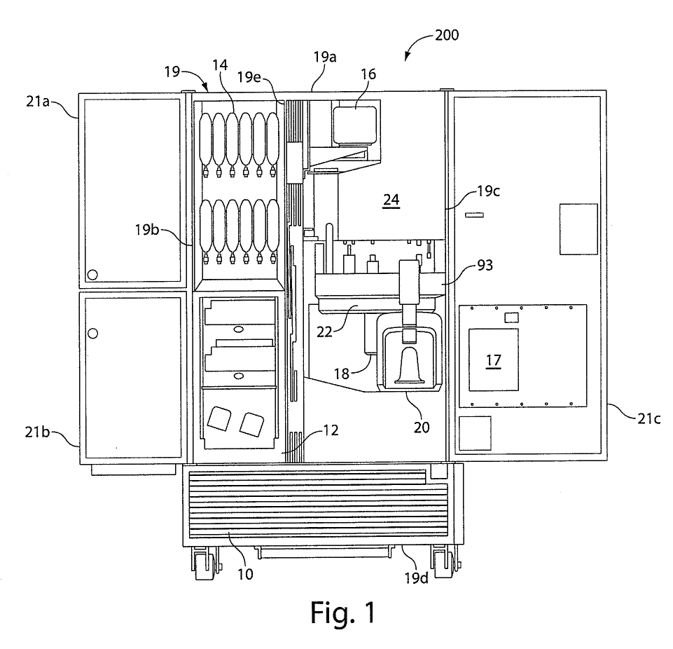

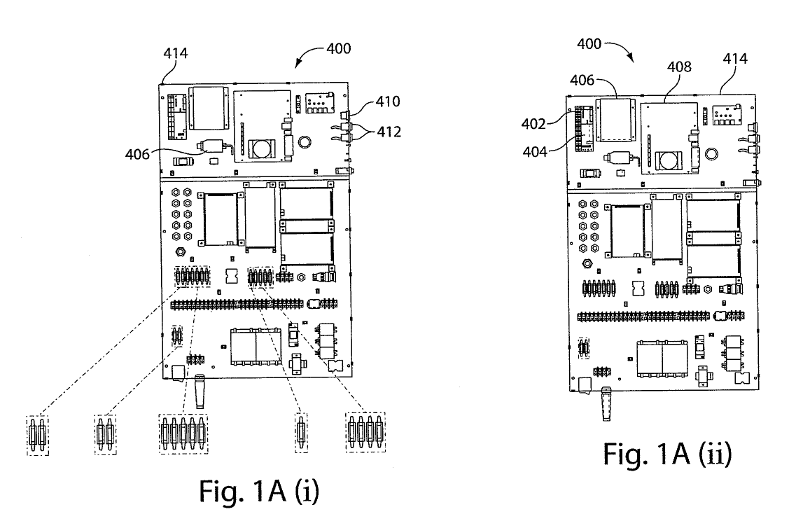

FIG. 1 is a front view of a food service machine (FSM) according to one embodiment of the invention;

FIGS. 1A (i) and (ii) are schematic views of a control box assembly for use with the FSM of FIG. 1;

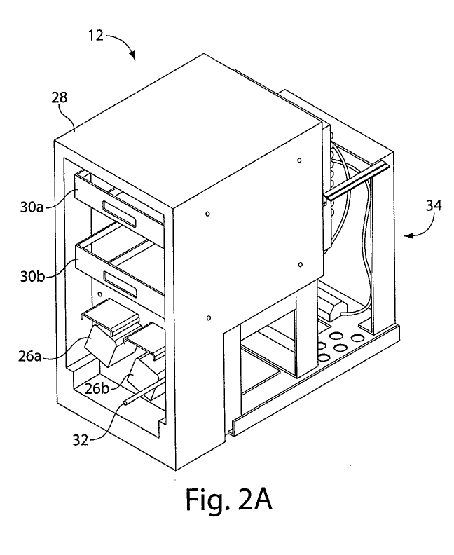

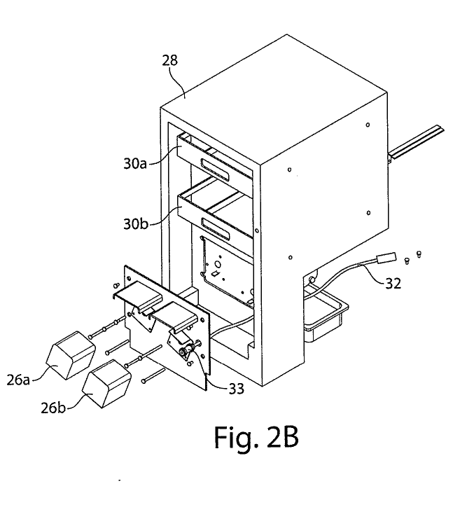

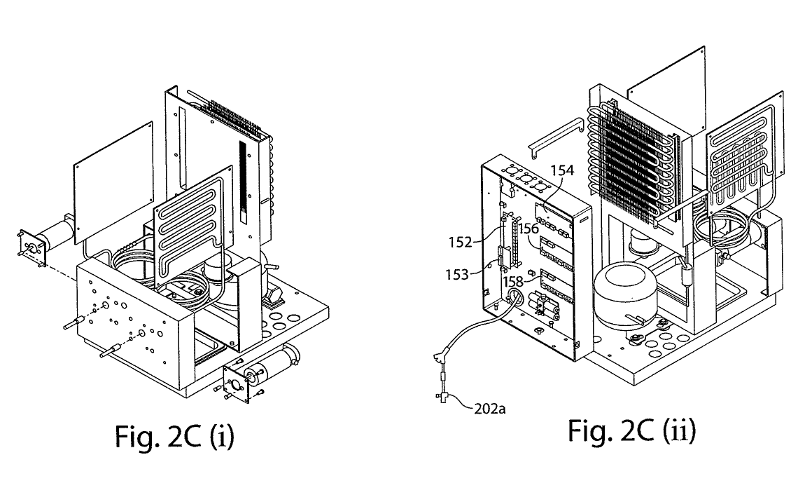

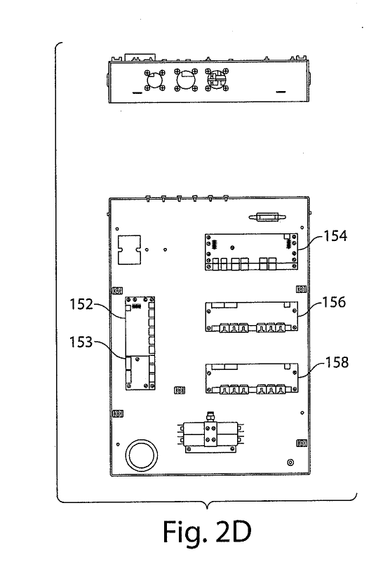

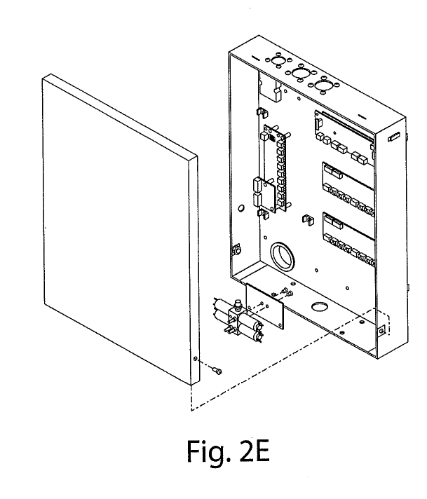

FIG. 2A is a perspective view of one embodiment of a base mix module for use in the food service machine (FSM) of FIG. 1;

FIG. 2B is an exploded view version of FIG. 2A;

FIGS. 2C(i) and (ii) are perspective views of the base refrigeration subsystem of the base mix module of FIG. 2A;

FIG. 2D is a schematic view of the control box for the base mix module of FIGS. 2A-2C;

FIG. 2E is a perspective view of the control box of FIG. 2D;

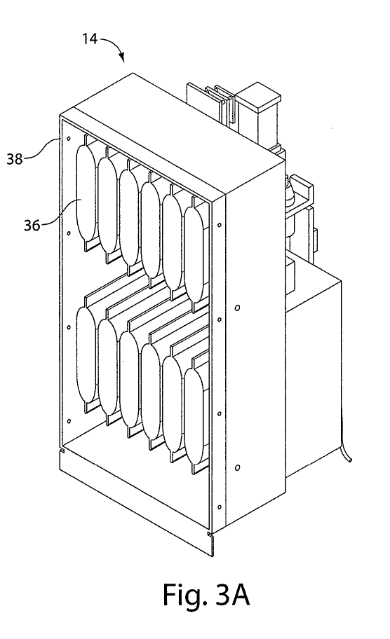

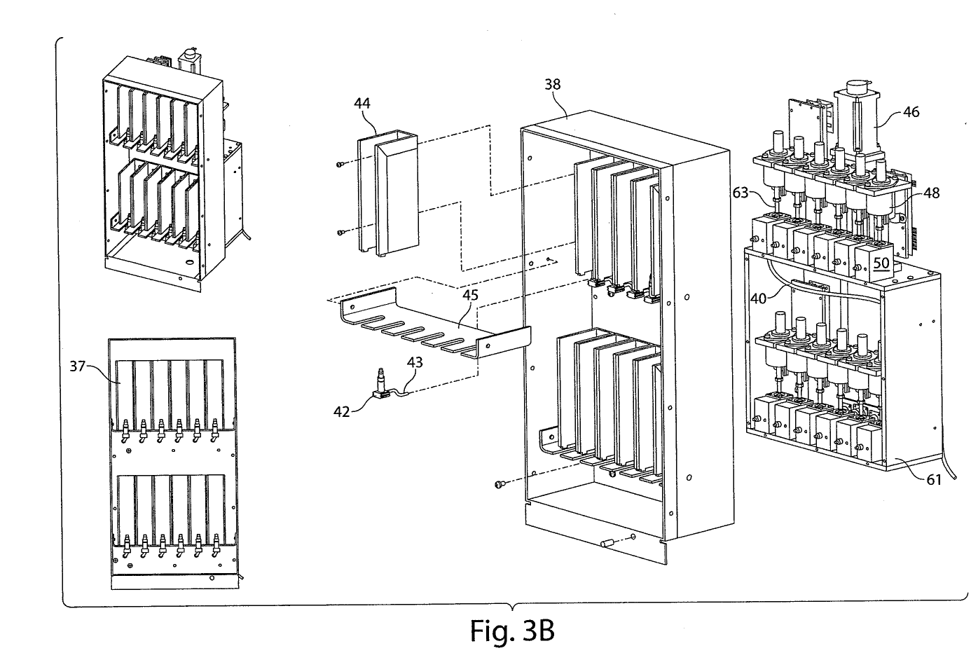

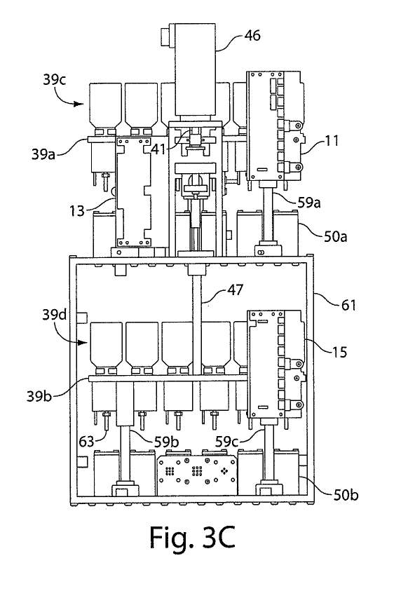

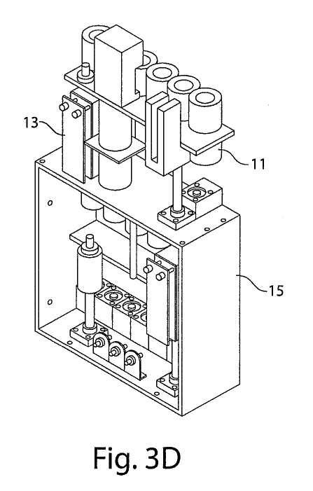

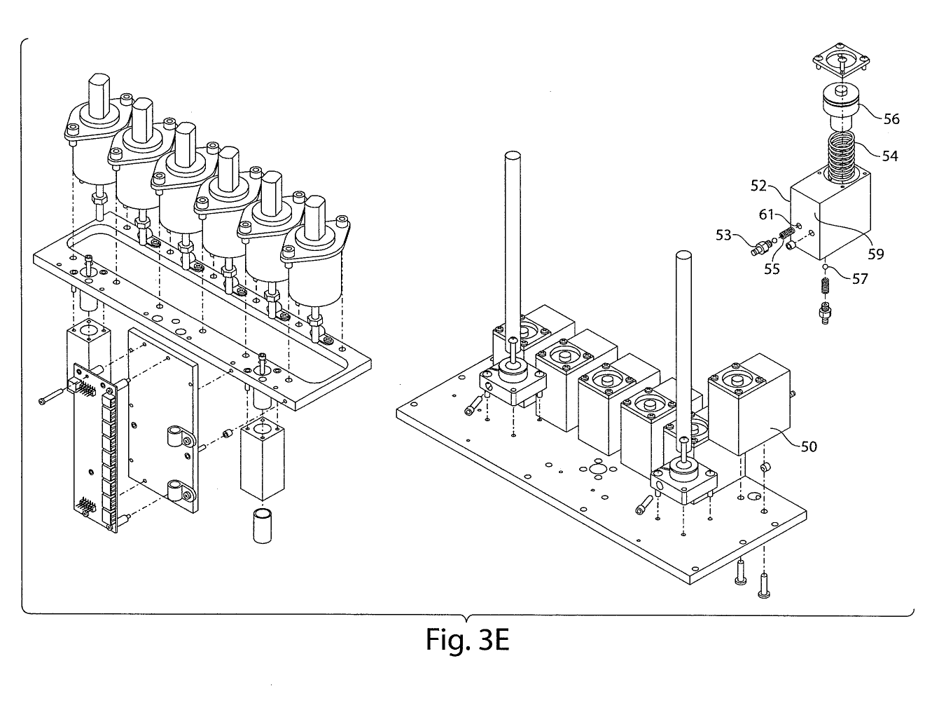

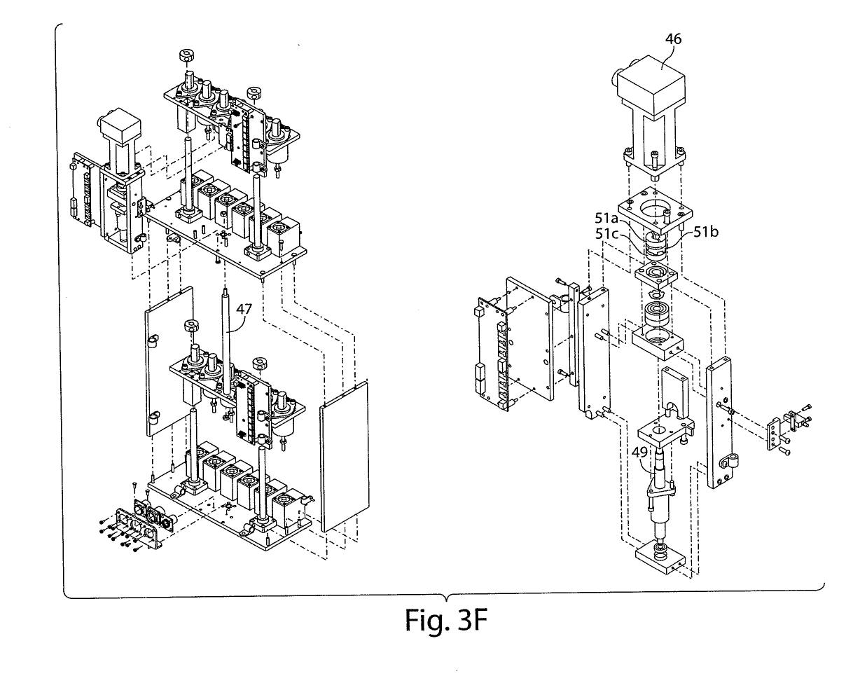

FIG. 3A is a perspective view of one embodiment of a flavor module for use in the FSM of FIG. 1;

FIG. 3B is an exploded schematic perspective view of FIG. 3A;

FIG. 3C is a back view of the flavor module of FIG. 3A;

FIG. 3D is perspective view of the back of the flavor module of FIG. 3A;

FIG. 3E is an exploded perspective view of a portion of FIG. 3A including a set of solenoids, a set of positive displacement pumps, a distributed control board, and a support plate;

FIG. 3F is another exploded schematic perspective view of portions of FIG. 3A including a linear drive;

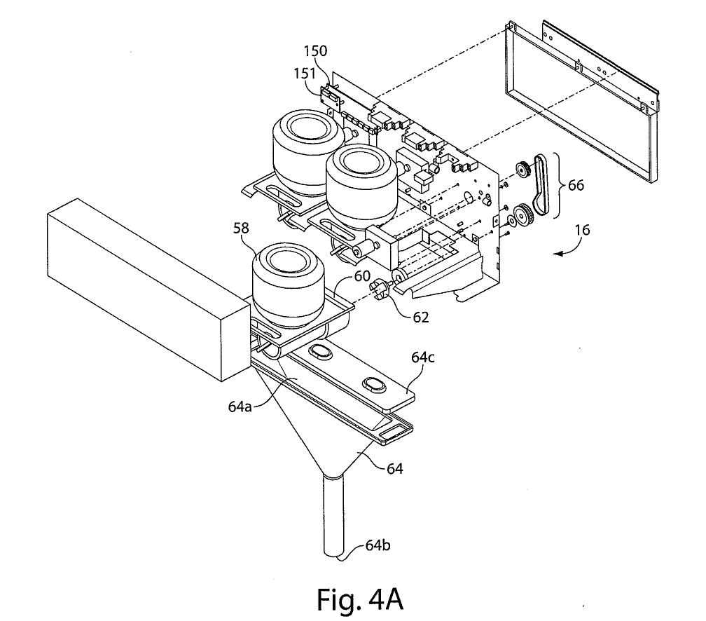

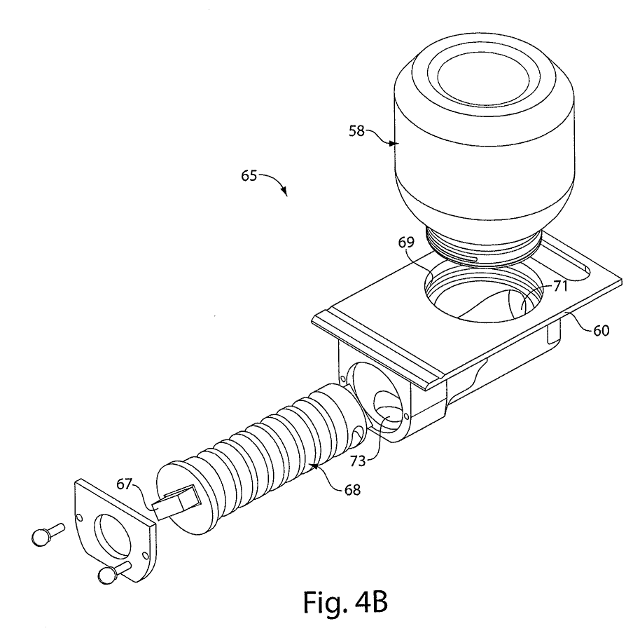

FIG. 4A is an exploded schematic perspective view of one embodiment of a mix-ins module for use in the FSM of FIG. 1;

FIG. 4B a mix-in assembly used in the mix-ins module of FIG. 4A;

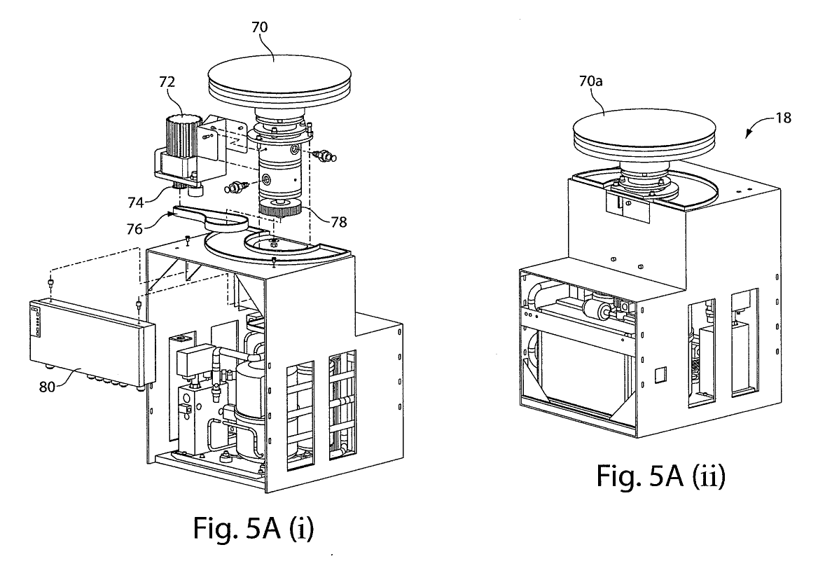

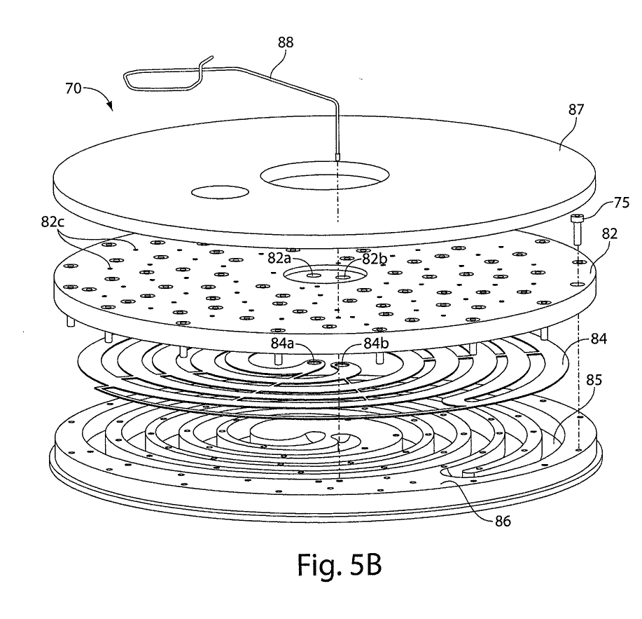

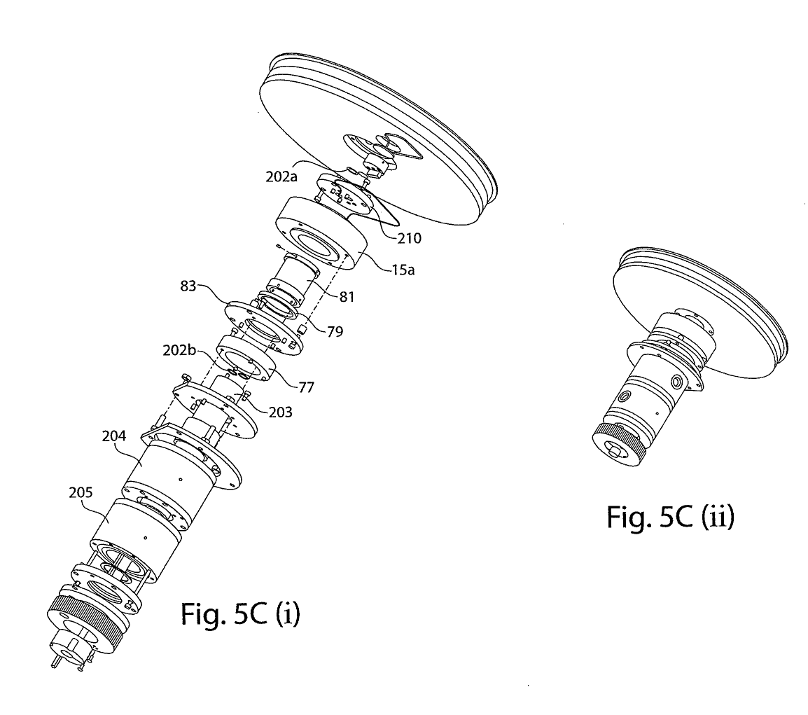

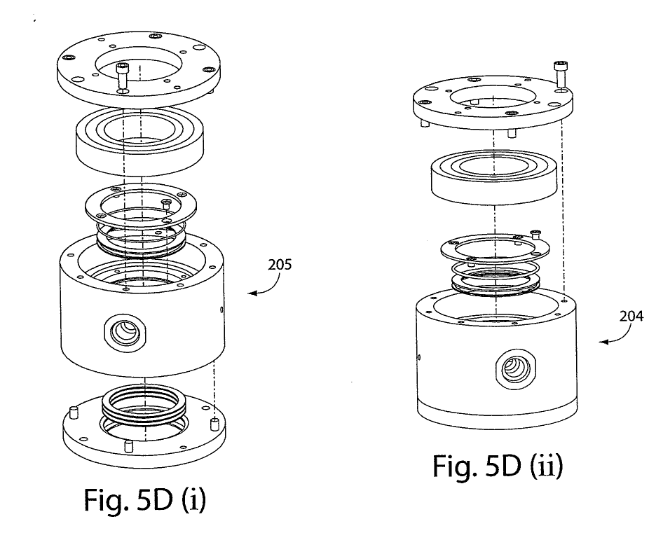

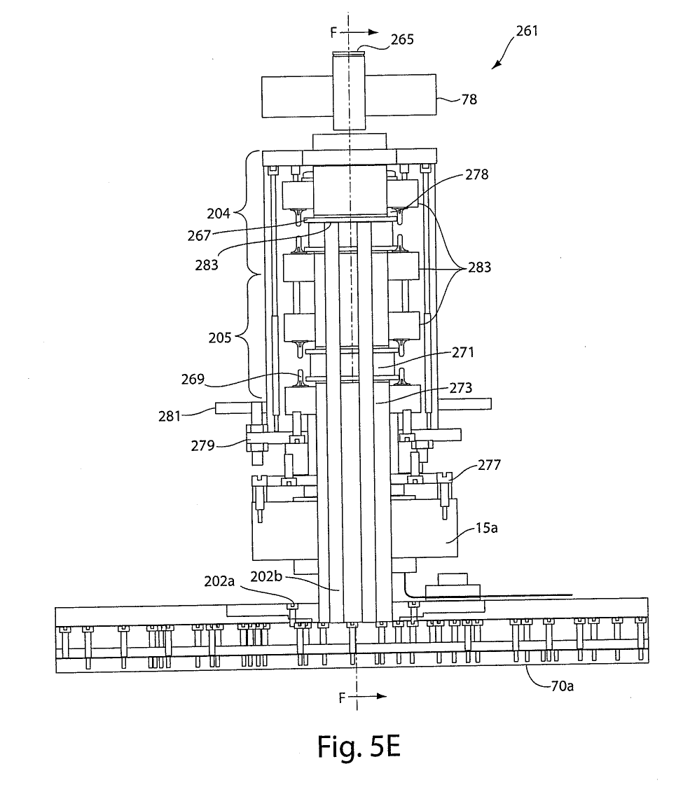

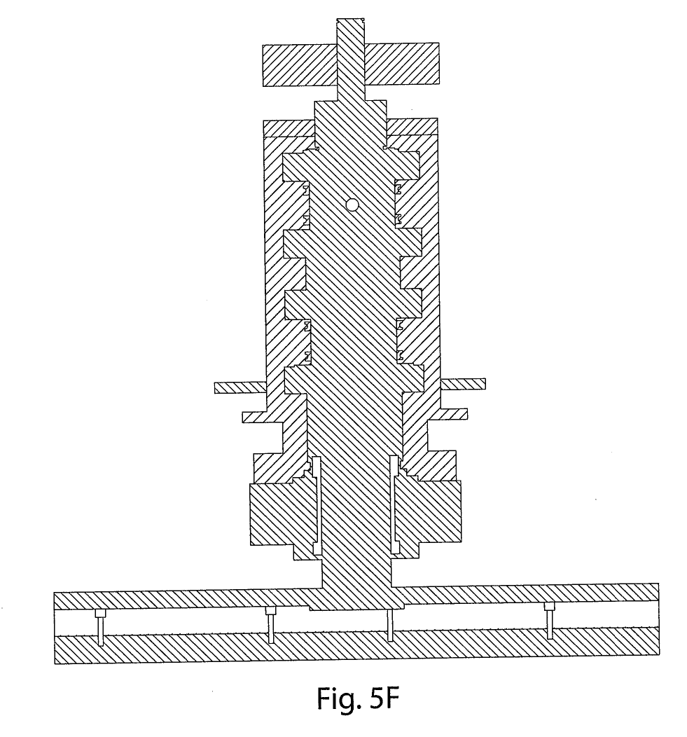

FIG. 5A(i) is an exploded schematic perspective view of one embodiment of a primary refrigeration system and food preparation apparatus for use in the FSM of FIG. 1;

FIG. 5A(ii) is an assembled schematic perspective view of the primary refrigeration system and food preparation apparatus of FIG. 5A(i);

FIG. 5B is an exploded perspective view of a freeze plate assembly of the food preparation apparatus of FIG. 5A;

FIG. 5C(i) is an exploded perspective view of a rotating freeze plate assembly (i.e., the food preparation apparatus) of FIG. 5A;

FIG. 5C(ii) is an assembled perspective view of the food preparation apparatus of FIG. 5C(i);

FIG. 5D(i) is an exploded perspective view of a lower seal housing assembly of the food preparation apparatus of FIG. 5C;

FIG. 5D(ii) is an exploded perspective view of an upper seal housing assembly of the food preparation apparatus of FIG. 5C;

FIG. 5E is a cross-sectional view of a portion of the food preparation apparatus of FIG. 5A;

FIG. 5F is a cross-sectional view of a portion of the food preparation apparatus, the view taken from perspective F-F shown in FIG. 5E;

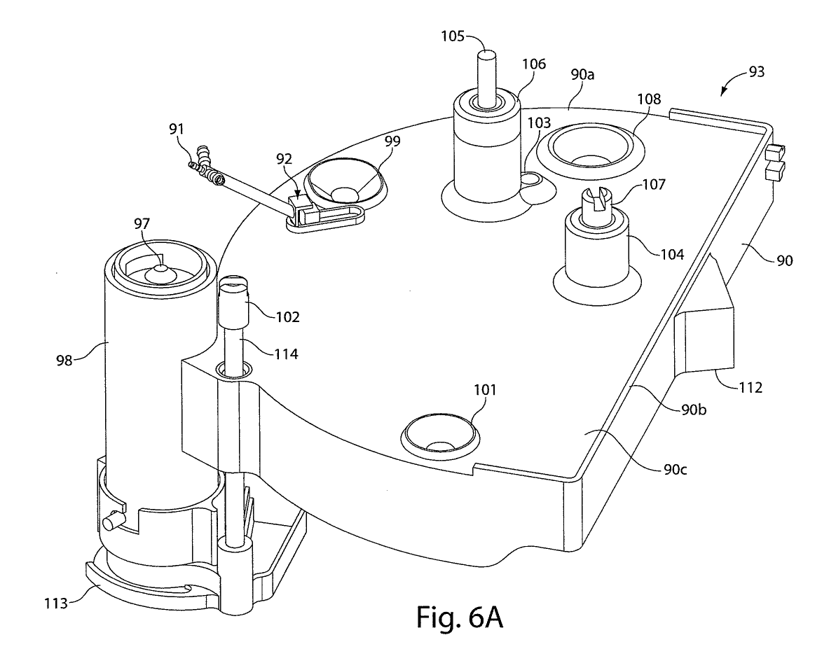

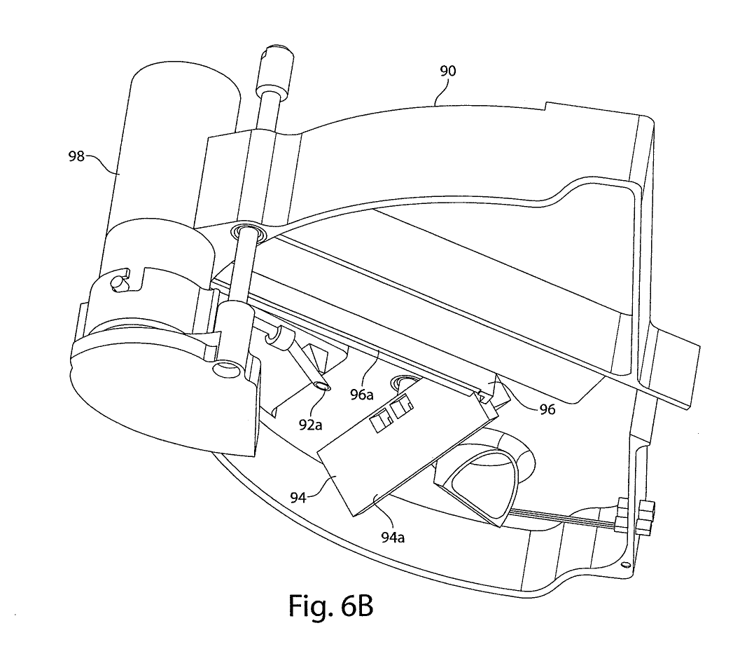

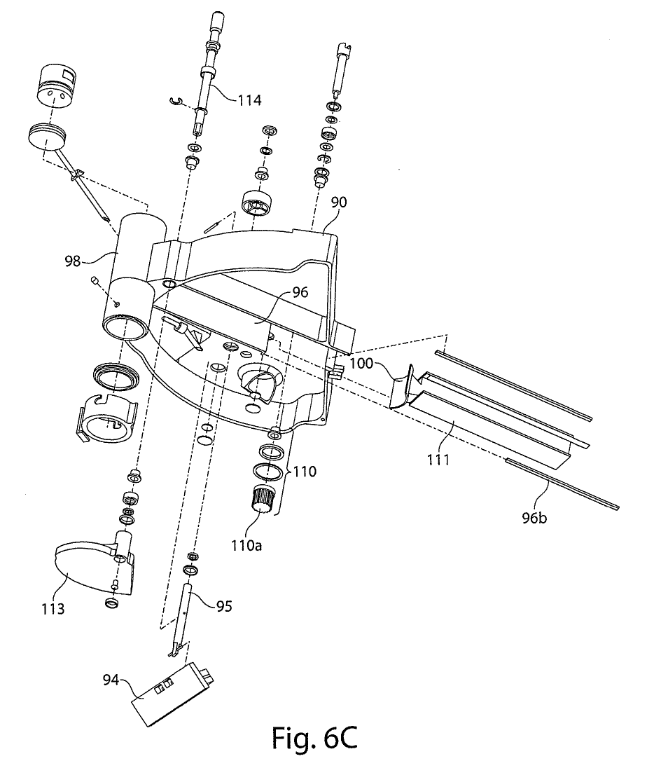

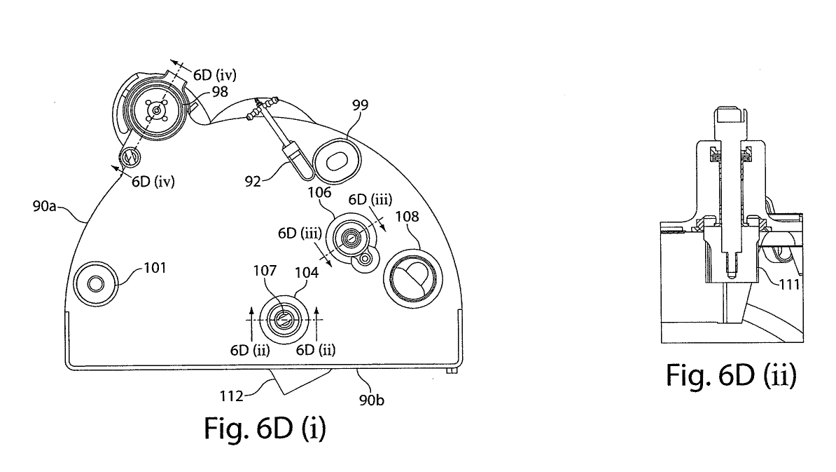

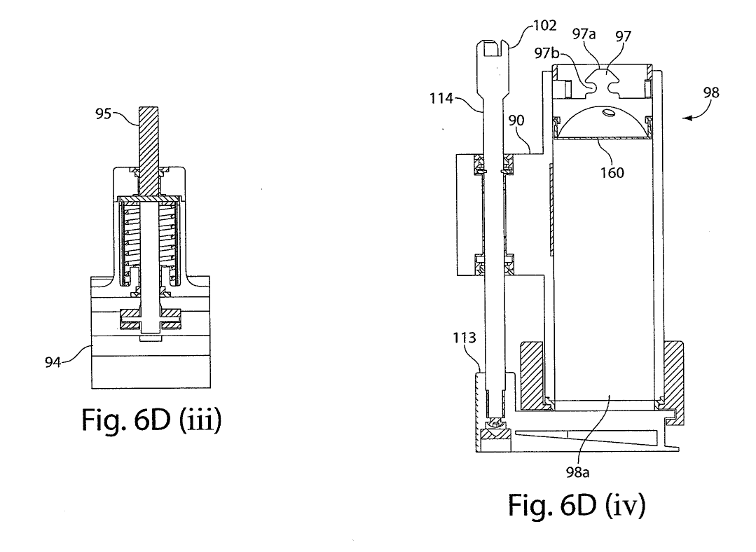

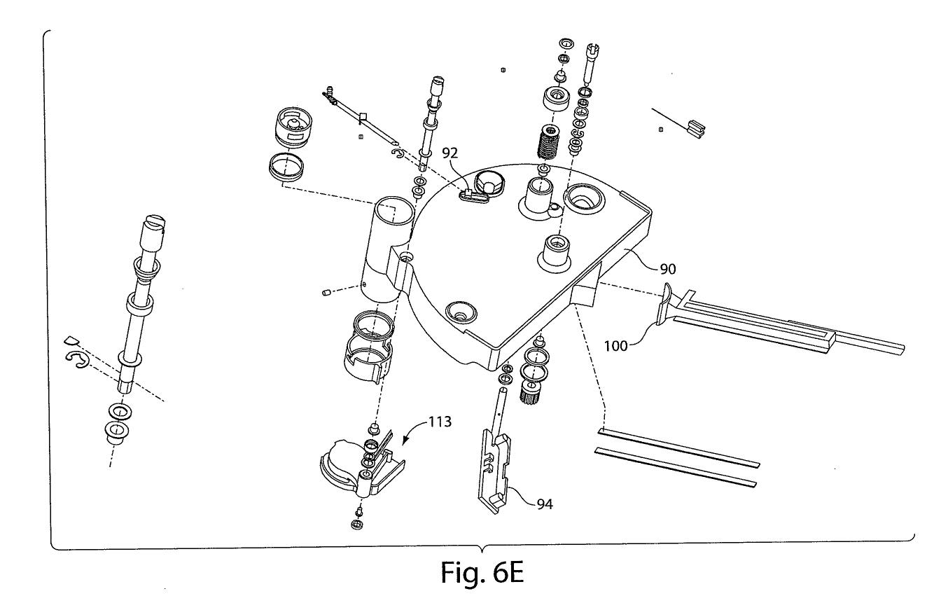

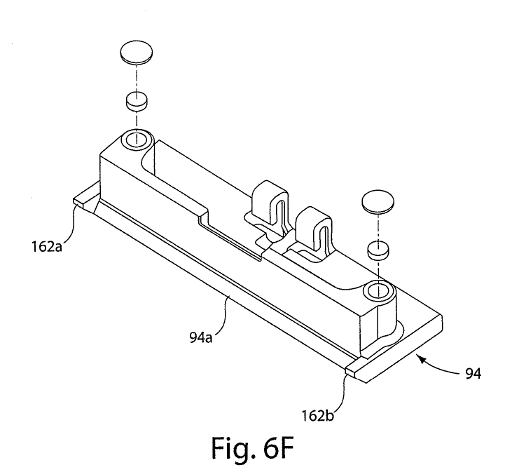

FIG. 6A is a top perspective view of one embodiment of a food cover assembly (FCA) for use in the FSM of FIG. 1;

FIG. 6B is a bottom perspective view of the FCA of FIG. 6A;

FIG. 6C is an exploded perspective view of the FCA of FIG. 6A;

FIG. 6D(i) is a top perspective view of the FCA of FIG. 6A;

FIG. 6D(ii) is a cross-sectional view of the pinion interface of the FCA of FIG. 6D(i);

FIG. 6D(iii) is a cross-sectional view of a level interface (including a squeegee) of the FCA of FIG. 6D(i);

FIG. 6D(iv) is a cross-sectional view of the forming/dispensing cylinder of the FCA of FIG. 6D(i);

FIG. 6E is a top perspective exploded view of the food zone cover of FIG. 6A;

FIG. 6F is an illustration of one embodiment of the squeegee of FIG. 6A;

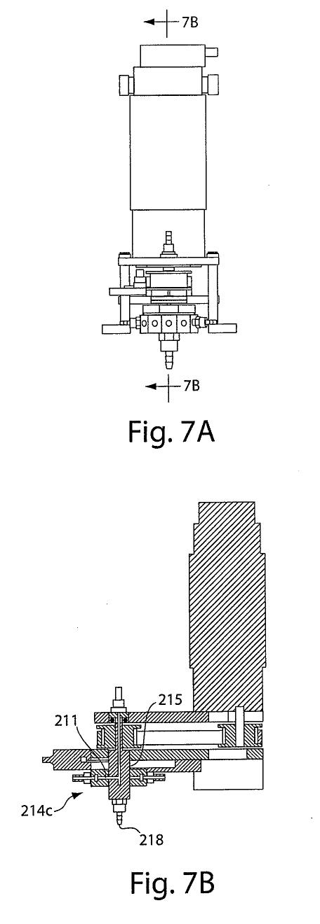

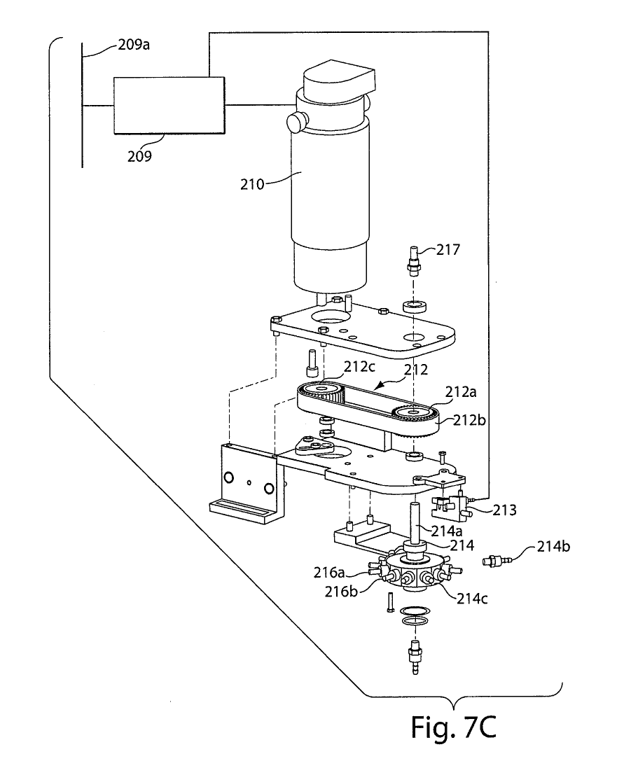

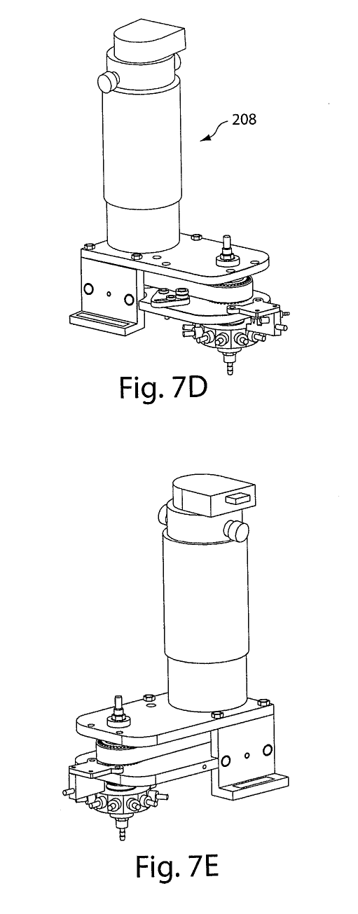

FIG. 7A is a schematic view of one embodiment of a flavor wheel assembly for use in the FSM of FIG. 1;

FIG. 7B is a cross-sectional view of the flavor wheel assembly of FIG. 7A;

FIG. 7C is an exploded top perspective view of the flavor wheel assembly of FIG. 7A;

FIGS. 7D and 7E are assembled top perspective views of the flavor wheel assembly of FIG. 7A;

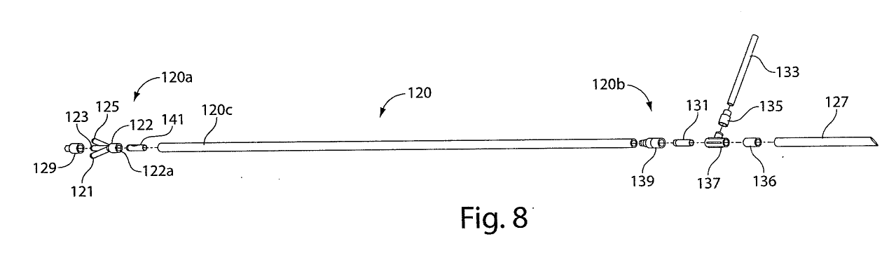

FIG. 8 is an exploded perspective view of one embodiment of a base aeration tube kit assembly (with a connection for connecting to the flavor module) for use in the FSM of FIG. 1;

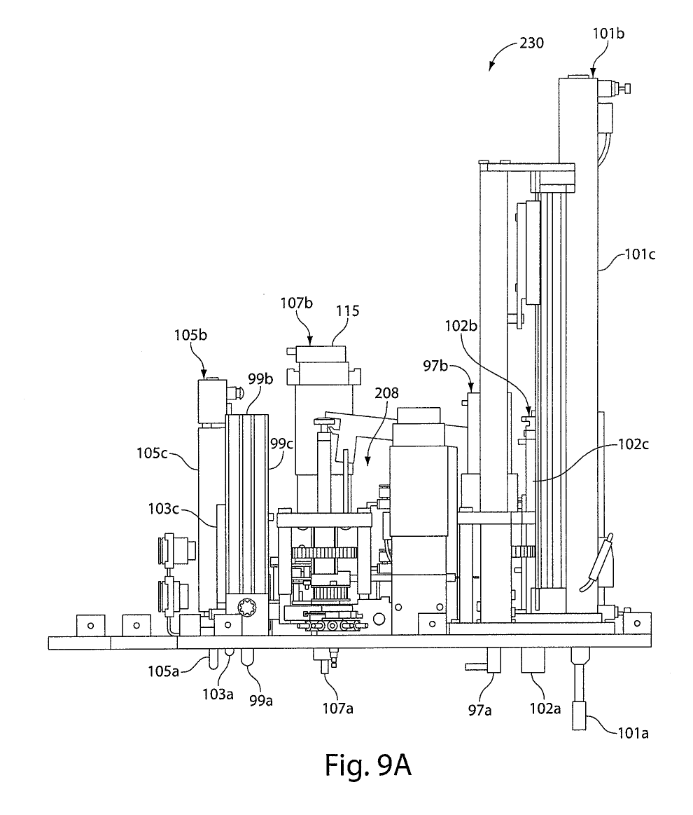

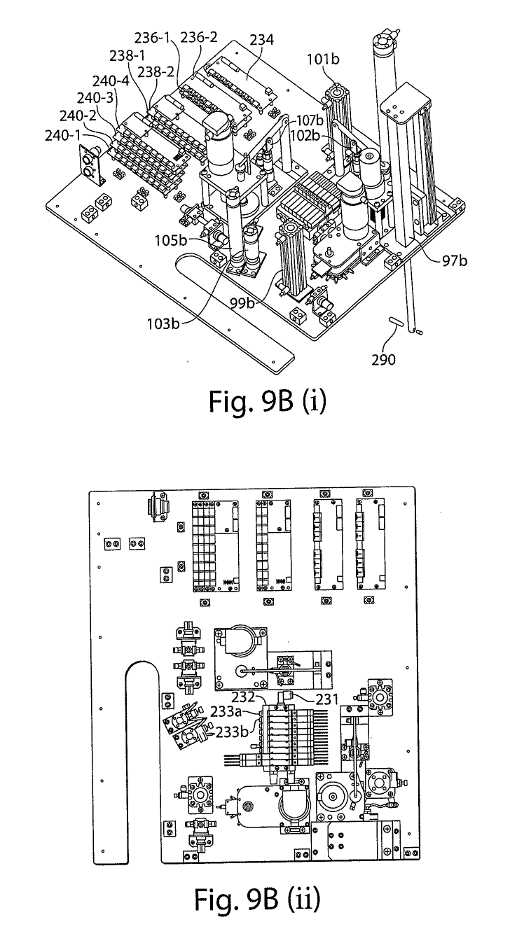

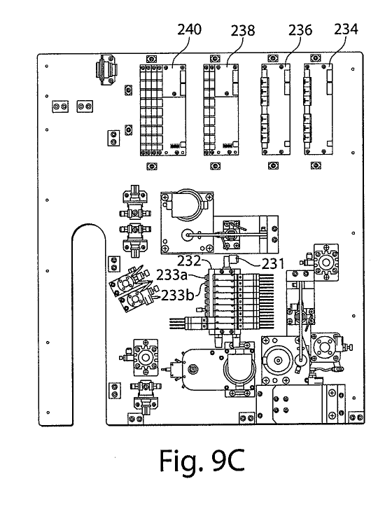

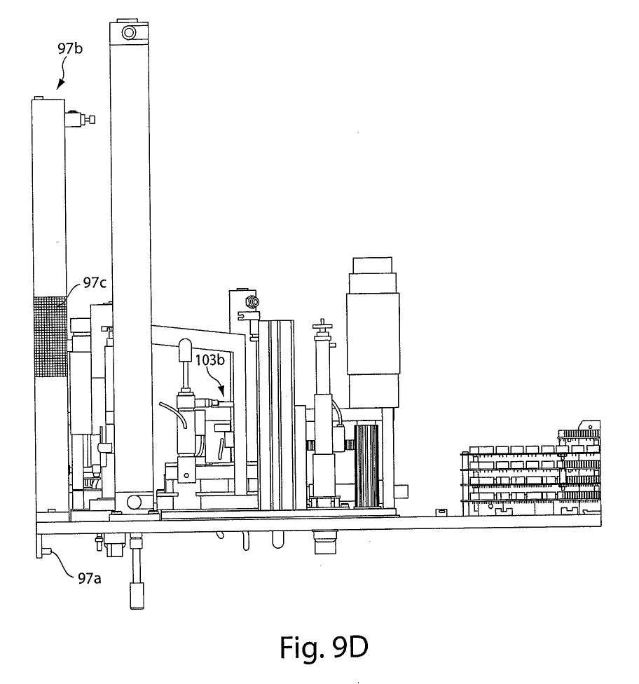

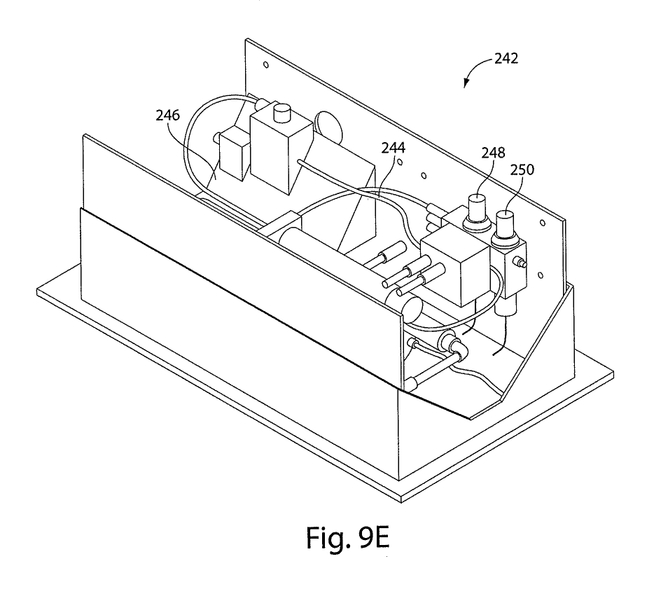

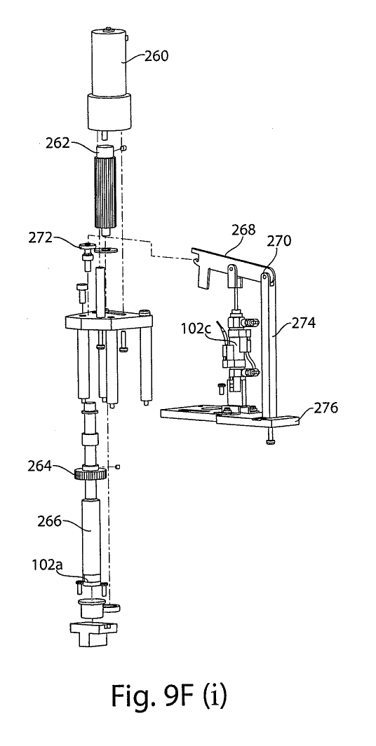

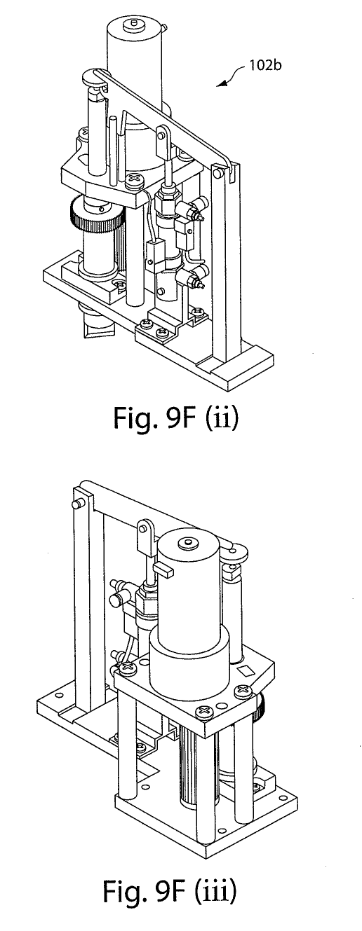

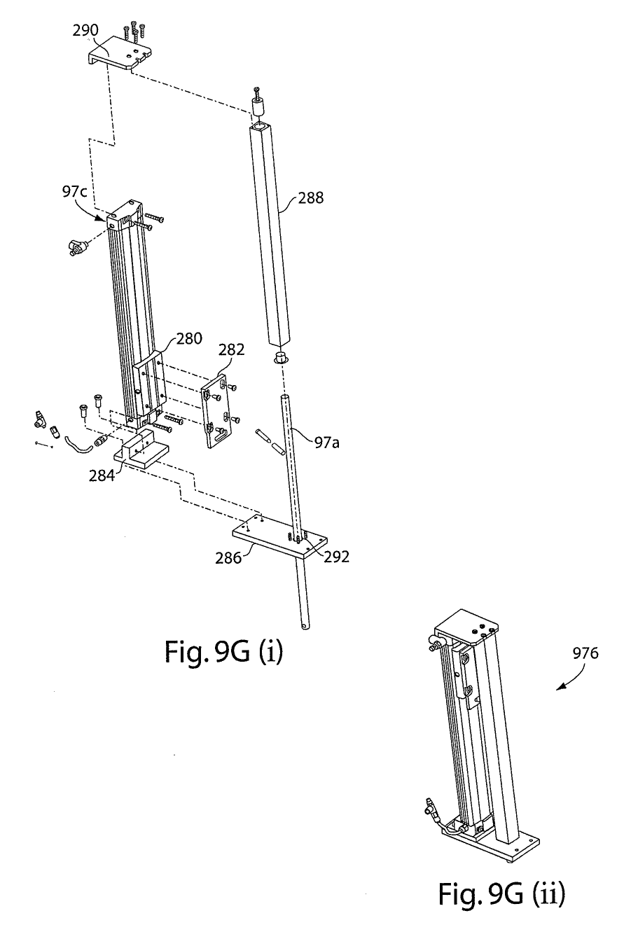

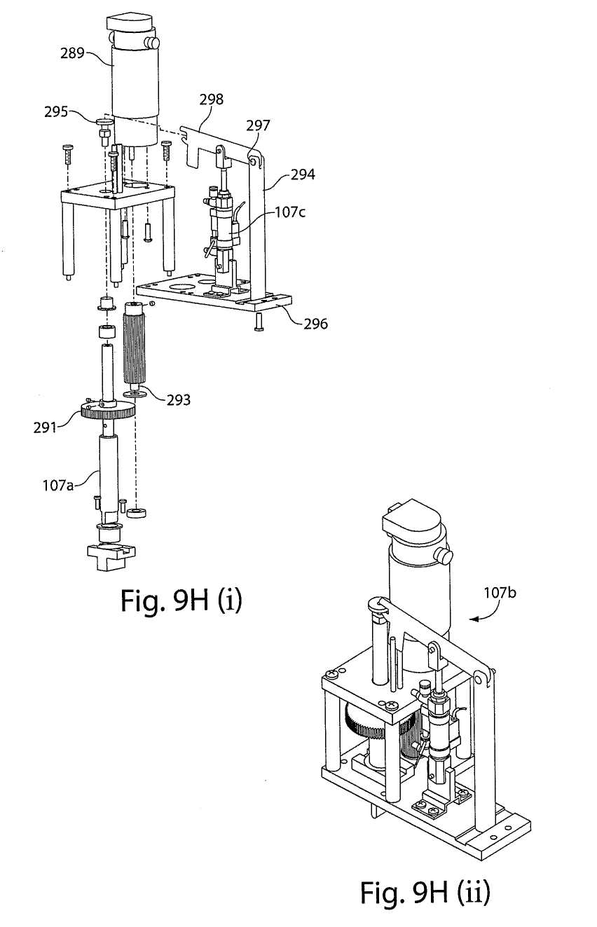

FIG. 9A is a front view of one embodiment of a process plate assembly, i.e., a process box, for use in the FSM of FIG. 1;

FIG. 9B(i) is a perspective view of the process box of FIG. 9A; FIG. 9B(ii) is a top view of the process box of FIG. 9A;

FIG. 9C is a top view of the process box of FIG. 9A;

FIG. 9D is a right side view of the process box of FIG. 9A;

FIG. 9E is a top perspective view of one embodiment of a pneumatic module for use in the FSM of FIG. 1;

FIG. 9F(i), (ii), and (iii) are perspective views of the packing plate piston assembly of the process box of FIG. 9A;

FIG. 9G(i) and (ii) are perspective views of the packing piston assembly of the process box of FIG. 9A;

FIG. 9H(i), (ii), and (iii) are perspective views of the pinion drive piston assembly of the process box of FIG. 9A;

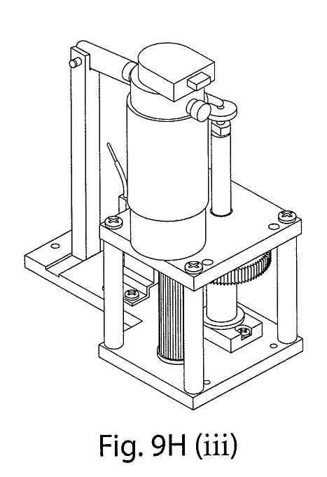

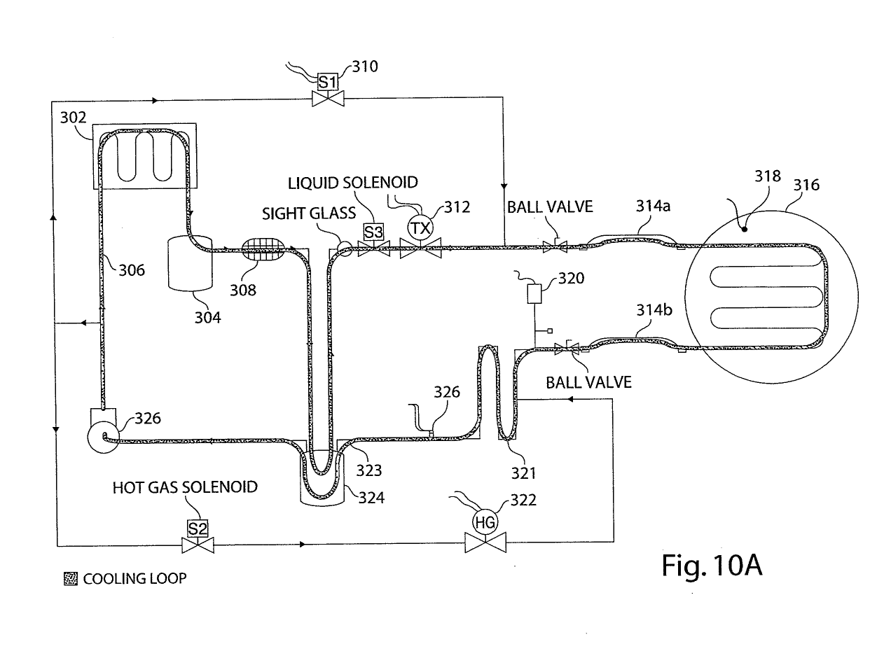

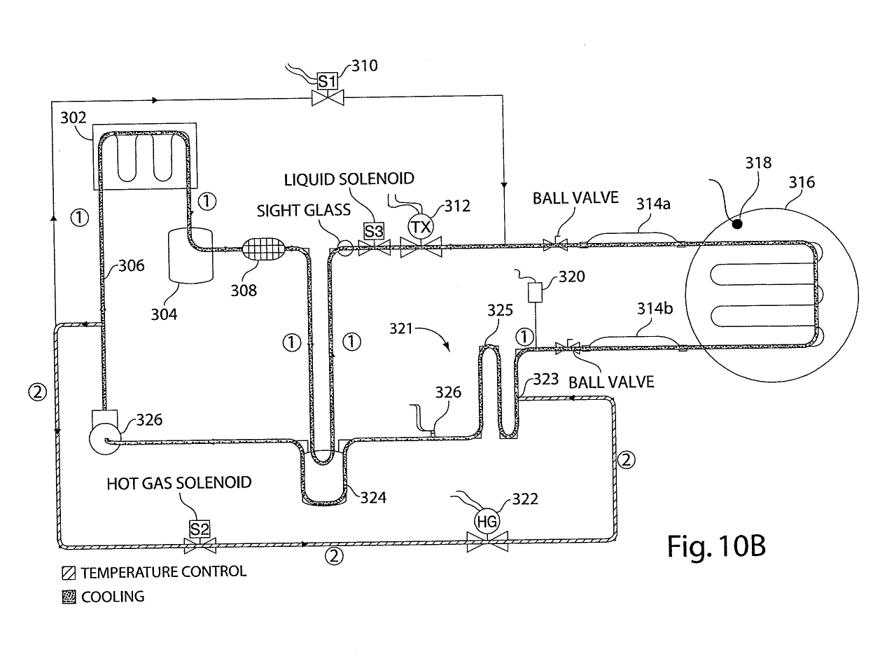

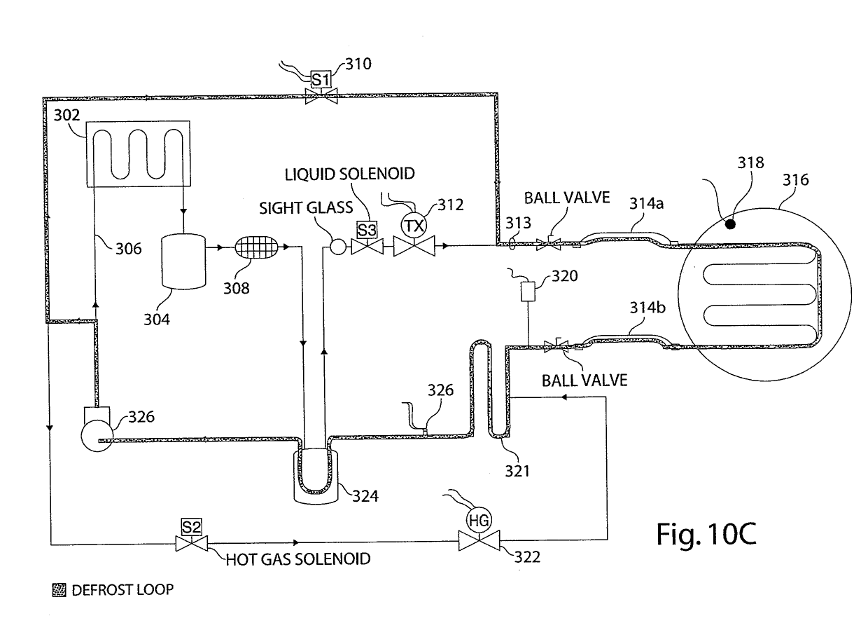

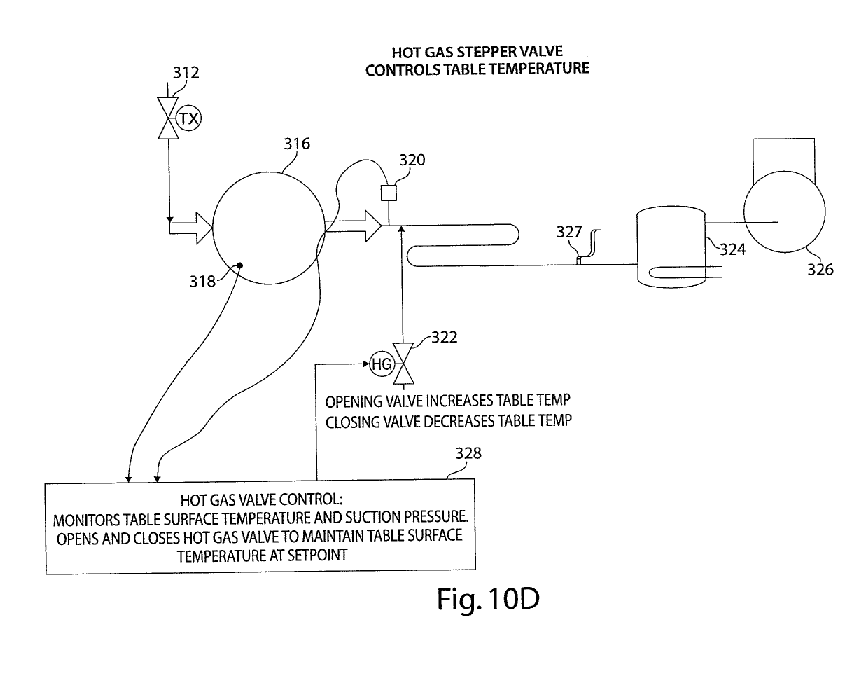

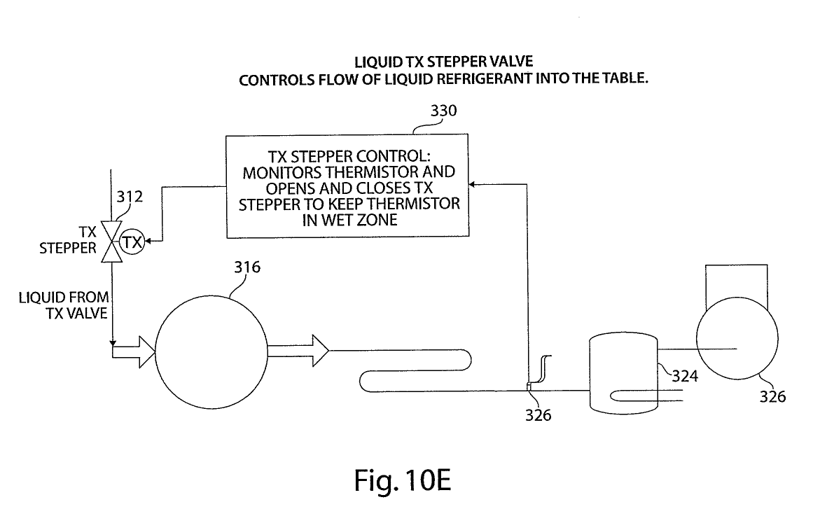

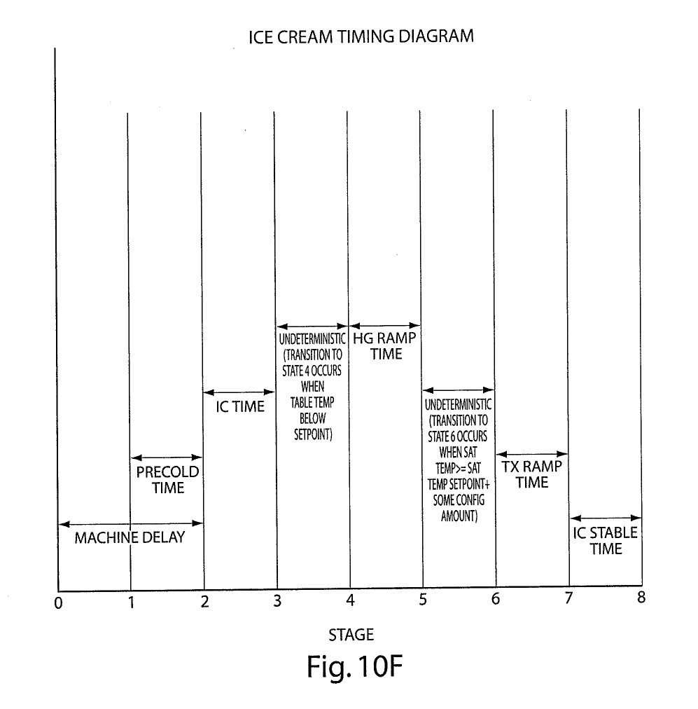

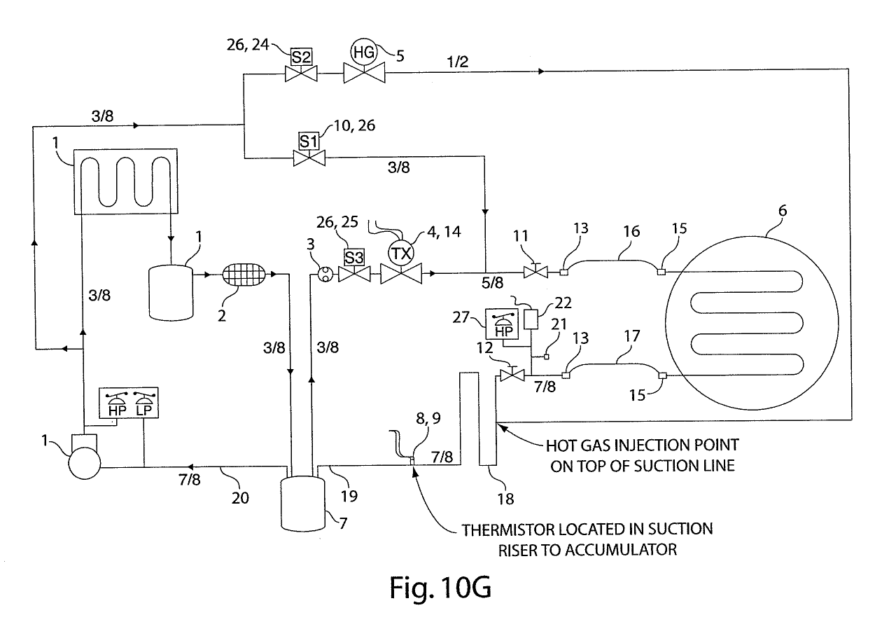

FIG. 10A is a schematic illustration of one embodiment of the primary refrigeration system of FIG. 5A and highlights a cooling loop;

FIG. 10B is the schematic illustration of FIG. 10A highlighting the cooling loop in combination with a temperature control loop;

FIG. 10C is the schematic illustration of FIG. 10A highlighting a defrost loop;

FIG. 10D is a schematic illustration of the hot gas valve control used with the system of FIG. 10A;

FIG. 10E is a schematic illustration of the liquid stepper control used with the system of FIG. 10A;

FIG. 10F is one embodiment of a timing diagram for operation of the PRS during a serving sequence;

FIG. 10G is the schematic illustration of FIG. 10A with each of the parts called out for use with a parts list; and

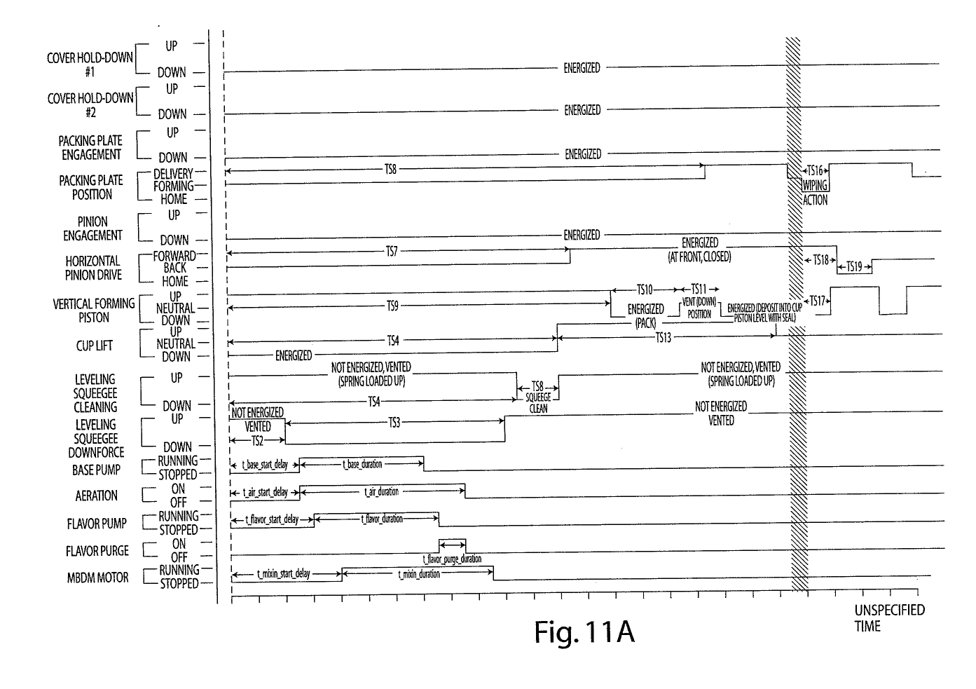

FIGS. 11A is one embodiment of a serving sequence timing diagram for operation of the FSM of FIG. 1.

### DETAILED DESCRIPTION OF THE INVENTION

The present invention relates to systems and methods for producing aerated and/or blended food products. While the invention may be used to produce a variety of products, it has particular application to the production of frozen confections such as ice cream and frozen yogurt. Consequently, we will describe the invention in that context. It should be understood, however, that various aspects of the invention to be described also have application to the making and dispensing of various other food products.

Referring to FIG. 1, an apparatus for producing food according to the invention is a stand-alone unit 200 housed in a cabinet 19 having a top wall 19a, opposite sidewalls 19b and 19c, a bottom wall 19d, and a middle separation wall 19e as well as a rear wall (not shown). The walls 19a-19e can act as covers. The front of the cabinet is open except for a low front wall 12 containing louvers to provide inlet air to a primary refrigeration unit, a base refrigeration unit and to pneumatics. The front opening into the cabinet may be closed by hinged doors 21a, 21b, 21c which may be swung between an open position wherein the doors allow access to the interior of the cabinet and a closed position wherein the doors cover the openings into the cabinet. Suitable means are provided for latching or locking each door in a closed position.

As shown in FIG. 1, a relatively large opening or portal 17 is provided in door 21c so that when the door is closed, the portal 17 provides access to a dispensing station 20 within the cabinet at which a customer may pick up a food product dispensed by the apparatus. Preferably, the portal 17 is provided with a door so that the portal is normally closed blocking access to the station 20. A customer may select the particular product to be dispensed by depressing the appropriate keys of a control panel mounted in the door 21c after viewing product availability. In the event the apparatus is being used as an automatic vending machine, the control panel may include the usual mechanisms for accepting coins, debit cards and currency and possibly delivering change in return. For advertising purposes, an illuminated display may be built into the front of a door, e.g., door 21c.

Having described the housing and the doors for the housing, this description now turns to an overview of the apparatus 200 of FIG. 1. One embodiment of an apparatus for producing a food product includes: a housing/frame 19; a base mix module 12 coupled to the frame and operative to provide refrigerated base mix and; a flavor module 14 coupled to the frame and operative to provide flavoring; a flavor selection assembly (shown in FIGS. 7A-7E and 9A) coupled to the frame and having an outlet 118 and a plurality of, e.g., twelve, flavoring inlets 116a, 116b, each inlet operative to receive a flavoring. The flavor selection assembly allows passage of a flavoring from a selected inlet to the outlet. The apparatus further includes a tube kit (shown in FIG. 8 as element 120) having a proximal end 120a including a first opening 121 coupled to the base mix module and a second opening 123 for receiving air. The tube kit has a distal end 120b coupled to the outlet of the flavor selection assembly. The tube kit combines base mix, air and flavoring to produce a flavored, aerated mix.

The apparatus for producing a food product can further include a mix-ins module (shown in FIG. 1 as element 16). The apparatus includes a food preparation assembly (FPA) 22 (shown in FIGS. 1) coupled to the frame. In one embodiment, the FPA includes a food zone cover (shown in FIG. 6A as element 93) adapted to receive the flavored, aerated mix from the distal end of the tube kit and mix-ins from the mix-ins module. The FPA then prepares food from the flavored aerated mix and mix-ins.

In one embodiment, the invention uses distributed computing to facilitate the testing, repair and/or replacement of the individual modules/components described above. More specifically, in one embodiment various modules/components have dedicated sub-controllers. Thus, in one embodiment, the base mix module 12 has a dedicated base mix module sub-controller adapted to operate the base mix module, the flavor module 14 has a dedicated flavor module sub-controller adapted to operate the flavor module, the flavor selection assembly has a flavor selection assembly sub-controller adapted to operate the flavor selection assembly, and the food preparation assembly has a dedicated food preparation assembly sub-controller adapted to operate the food preparation assembly. In one embodiment, the sub-controllers can be conventional cards implemented in a combination of hardware and firmware and designed to comply with the controller area network open (CANopen) specification, a standardized embedded network with flexible configuration capabilities. The CANopen specification is available from CAN in Automation (CiA) of Erlangen, Germany, an international users' and manufacturers' organization that develops and supports CAN-based higher-layer protocols.

With reference to FIGS. 1A(i) and (ii), the apparatus further includes a control and power distribution box 400. The box includes an apparatus or main controller 414 in communication with the base mix module sub-controller, the flavor module sub-controller, the flavor selection assembly sub-controller, and the food preparation assembly sub-controller to provide instructions to the sub-controllers so as to operate the apparatus. Similarly, the mix-ins module can include a dedicated mix-ins module sub-controller in communication with the apparatus/main controller adapted to operate the mix-ins module. In one embodiment, the main controller communicates with the sub-controllers over a bus using CANOpen, a controller area network-based higher layer protocol. CANOpen is designed for motion-oriented machine control networks, such as handling systems.

In the illustrated embodiment, the main controller 414 includes a digital I/O board 404 with an associated CANOpen gateway 402, a CANOpen adaptor 406 in communication with the CANOpen gateway, a motherboard 408 in communication with the digital I/O board 404, the motherboard having an associated hard drive 406. The main controller further includes an Ethernet connection 410 and two USB connectors 412 in communication with the motherboard for providing external access to the motherboard.

The Base Mix Module

With reference to FIGS. 2A and 2B, one embodiment of a base mix module includes: base mix holding bays 30a, 30b; base mix tubes 32 each having a proximal end and a distal end (the proximal end adapted for coupling to a bag held in one of the base mix holding bays); pumps 26a, 26b, e.g., peristolic pumps, each pump coupled to a base mix tube, the base mix tubes couple to a tube kit (shown in FIG. 8) forming a tube assembly; a source of compressed air (shown in FIG. 9E as element 202) couples to the base mix tube, the source of compressed air controlled in part by an air control valve 202a (shown in FIG. 2C(ii)). The air control valve is operative to control the amount of air provided to the tube kit; and a base mix module sub-controller coupled to the pumps and operative to control the pump and the air control valve so that, when base mix is loaded into the base mix holding bay, the base mix module sub-controller controls the amount of base mix and air injected into the tube assembly.

More specifically and with reference to FIGS. 2C(i) and (ii), and FIGS. 2D and 2E, in the illustrated embodiment the base mix module sub-controller includes four (4) cards, i.e., a digital input/output (I/O) board 153 with a CANOpen gateway 153, an analog I/O board 154, a first motor control board 156 for operating the first pump 26a, and a second motor control board 158 for operating the second pump 26b (the pumps are shown in FIG. 2A). In one embodiment, the analog board and the motor control boards are daisy-chained to the digital I/O board. The purpose of the analog card is to receive thermocouple information from appropriately placed thermocouple(s), the thermocouple information allows the system to control the base refrigeration system to hold the base mix temperature within a specified temperature range, e.g., at or below about 41 degrees Fahrenheit.

The Flavor Module

With reference to FIGS. 3A to 3F, one embodiment of a flavor module 14 includes a plurality of flavor packet holding bays 37 defined by brackets 44 and shelf (shelves) 45. Each holding bay holds a flavor packet 36. The illustrated flavor module 14 includes a plurality of, e.g., 12, positive displacement pumps 50 attached to pump frame 61 (shown in FIGS. 3B and 3C) to form two pump banks 50a, 50b. Each pump couples to a holding bay via a fitting 42 and tubing 43. An operator can attach the fitting 42 to a container (e.g., a bag) of flavoring and insert the flavor container into a holding bay 37. Flavor flows from a flavor container through the fitting 42 and tubing 43 into a displacement pump 50. Thus, displacement pumps 50 receive flavoring from flavor containers/packets held in the holding bays.

With reference to Detail D of FIG. 3E, in one embodiment the pump includes a piston 56 seated on top of the pump body 59 and supported by a piston spring 54. The pump further includes a check valve system. Each check valve includes a barb fitting 53, a spring 55, and a ball 57. An inlet check valve is on the front side 59, i.e., the side having two holes, and an outlet check valve is on the bottom of the pump.

The illustrated flavor module 14 includes a plurality of, e.g., twelve, electrical solenoids 48 coupled to slidable support plates 39a, 39b to form two solenoid banks 39c, 39d. Support plate 39a slidably couples with two support shafts (one of which is designated 59a and the other of which is not shown). Similarly, support plate 39b slidably couples to two support shafts 59b, 59c. Thus, the support plates can slide up and down on their support shafts.

The flavor module includes a linear drive motor 46 coupled to the slidable, support plates 39a, 39b to drive the support plates along the support shafts so as to bring the solenoid banks in (or out of) contact with the pump banks. When the solenoid banks come in contact with the pump banks each solenoid engages with an associated displacement pump 50 to cause at least one displacement pump to dispense flavoring. The flavor module further includes a flavor module sub-controller in communication with each of the solenoids and the linear drive motor. The sub-controller controls each of the solenoids and the linear drive motor so as to select and energize at least one solenoid and to operate the linear drive motor to drive the slidable support plates moving the solenoid bank relative to the displacement pumps such that an energized solenoid causes an associated displacement pump to dispense flavoring. More specifically, in the illustrated embodiment the flavor module sub controller includes a linear drive board 13 for operating the linear drive 46, a first solenoid bank board 11 for operating the first solenoid bank 39c, and a second solenoid bank board 15 for operating the second solenoid bank 39d. Thus, in one embodiment the system uses a single precisely controlled conventional linear actuator to drive and pump a number of, e.g., twelve, different flavors.

With reference to FIGS. 3C and 3F, linear drive motor 46 includes a drive shaft 41 connected via a coupling assembly (including hubs 51a, 51c and disc 51b) to a male/female screw (not shown). The male part of the screw is on a coupler shaft 47 and the female part is on the housing. The male/female screw assembly provides precise position control. The precision control assembly is a conventional assembly. As noted above, support plates 39a, 39b support solenoids to form solenoid banks 39c, 39d. The coupler shaft 47 coming down from the linear motor 46 directly attaches to the support plates 39a, 39b. As noted above, the top support plate 39a has two support shafts and the bottom support plate 39b has two support shafts. The support shafts connect to the support plates with precise bearings to keep the support plates parallel and square with each other so that as the linear drive moves the support plates, it moves both plates simultaneously and in a controlled manner. In other words, in one embodiment the lead screw and motor assembly move the top plate and the bottom plate as a single unit.

In operation when a user selects a flavor, the flavor module control scheme determines which pump—e.g., of twelve available pumps—corresponds with a selected flavor/pump. The flavor module control scheme run by the main controller energizes the solenoid associated with the selected flavor. Energizing the appropriate solenoid locks the solenoid rod 63 extending from the bottom of the solenoid. All other solenoids are left in an un-energized state, which allows their rods to move up and down freely. Then the linear actuator drives the solenoid banks down into contact with the pump banks. A flavor module sub-controller, e.g., an appropriately programmed PC, provides instructions to the linear actuator on how fast to accelerate, how fast to move through the full acceleration and how long to operate which determines the displacement (length of stroke) of the single linear displacement motor.

The solenoid rod for the energized solenoid is stationary and all the other solenoid rods are free to move longitudinally, e.g., up and down. Thus only the solenoid rod for the energized solenoid pushes down on an associated pump piston 56, which is resisted by spring 54. The other 11 solenoids are at rest and their solenoid rods are thus free to move inside their associated solenoid bodies. In other words, when the metal rod inside the coil of the resting, i.e., non-energized, solenoid encounters a pump piston 56 it merely slides in the solenoid body without displacing the piston 56.

The flavor pumps are already full of flavor because of a previous stroke. The linear actuator moves down a precise amount for the proper displacement of support plates 39a, 39b and associated solenoid banks 39c, 39d. As a result, the rod of a selected/energized solenoid pushes down on its associated pump piston 56 and, consequently, the associated pump ejects flavor via its outlet to a flavor selection assembly, e.g., a flavor wheel. Pushing against piston 56 displaces the lower check valve, and drives material out into a flavor selection assembly, e.g., a flavor wheel. Then, as the linear actuator moves back in a controlled manner (not an instantaneous release) to its home position, or base position, the check valve on the bottom seats itself, and the inlet check valve on the front of the pump unseats itself creating a suction on an associated flavor storage bag and the pump refills with flavoring. Thus, a singular linear drive pumps at least one of a plurality of, e.g., twelve, different flavors.

The Mix-ins Module

With reference to FIGS. 4A and 4B, one embodiment of a mix-ins/dried goods module includes a plurality of mix-in assemblies 65. Each assembly includes an auger block 60 forming a storage bottle hole 69 (adapted to receive a mix-in storage bottle 58); an auger passage 71 connected to the bottle hole; and a dispensing hole 73 connected to the auger passage. Each assembly further includes an auger 68 adapted to sit in the auger passage of the auger block, the auger having an engagable end 67. The module includes a plurality of drive assemblies 66 coupled to the engagable end of the augers via auger drive 62 and operative to drive the augers.

The module includes a trough assembly 64 having a collection slot 64a and a dispensing opening 64b. The collection slot couples to the dispensing holes of the plurality of mix-in assemblies. In one embodiment, the trough assembly includes a trough cover 64c. The trough assembly receives mix-ins from the mix-in assemblies and dispenses the mix-ins via dispensing opening 64b. The module further includes a mix-ins module sub-controller in communication with each of the drive assemblies. The sub-controller controls the drive assemblies so that when mix-ins bottles are loaded into the mix-ins module the sub-controller drives the engagable ends to turn the augers to dispense mix-ins. In the illustrated embodiment, the mix-ins module sub-controller includes a motor control board 150 for operating a motor (not shown) that drives the drive assemblies. The mix-ins sub-controller further includes a CANOpen gateway board 151 in communication with the motor control board 150 and with the main controller via a bus.

Food Preparation Apparatus/Assembly

With reference to FIGS. 5A-5F, an apparatus for preparing food includes a food surface assembly (FSA) 70, e.g., a freeze surface assembly, having a central axis and a periphery. The assembly, shown upside down in FIG. 5B, includes an upper freeze plate 86 having a first face and a second face. In one embodiment, the base material is aluminum, which facilitates heat transfer and is damage resistant and low weight relative to other practical materials. The first face forms a non-stick rotary freezing surface, which readily releases food products at low temperatures. The first face is a highly polished nickel-plated surface. The nickel plating provides strength and is conventional for food preparation applications. The nickel plating facilitates the system's ability to scrape ice cream off the surface without the ice cream sticking to the surface.

The second face has a refrigerant channel 85 operative to pass refrigerant. The assembly includes a gasket 84 adapted to couple to the upper freeze plate and operative to reduce cross flow of refrigerant. In one embodiment, the gasket is made of a conventional type of neoprene specifically designed for refrigerant applications. The assembly includes a lower freeze plate 82 coupled to the upper freeze plate so as to sandwich the gasket between the lower and upper freeze plates. The lower freeze plate has a first face and a second face. The first face seals the refrigerant channel leaving the refrigerant channel with an entrance hole 82a and an exit hole 82b. A number of screws attach the bottom freeze plate 82 to the upper freeze plate 86. Using a pattern of fastening that places screws adjacent to both sides of the refrigerant channel helps to maintain the channel and facilitates the function of gasket 84.

Thus, the food surface assembly creates refrigerant passages for the refrigerant to enter the FSA, to circulate around the entire channel 85 and then exit. Liquid refrigerant comes in to entrance hole 82a, moves through the entire channel and then exits via exit hole 82b. In an alternative embodiment, copper tubes are pressed into features machined into the upper freeze plate. Elimination of the copper tubing may improve the heat transfer characteristic. The assembly further includes an insulation plate 87 coupled to the lower freeze plate and operative to provide insulation to the food surface assembly. In one embodiment, the insulation plate is foam insulation that is glued to the lower freeze plate 82. The lower freeze plate 82 includes a number of holes 82c that are not used for fastening, but that are used for pressure relief so that if the system builds up excessive pressure the pressure will be relieved via the holes in the lower freeze plate.

A thermocouple assembly 88 passes through the lower freeze plate 82, and is epoxied with silver filled epoxy to the upper freeze plate 86 to within between 0.005 and 0.01 of an inch from the top of the surface 70a. The thermocouple is part of a system that measures the surface temperature and acts as one of a plurality of feedback loops for temperature control.

The apparatus for preparing food includes a drive shaft 65 (shown in FIG. 5E) coupled to the food surface assembly. With reference to FIG. 5A, the apparatus further includes a drive motor 72 coupled to the drive shaft 65 and operative to rotate the drive shaft causing rotation of the rotary surface about the central axis. More specifically, the drive motor 72 drives a pulley 74 that, in turn, drives a timing belt 76 to drive a pulley 78 attached to the drive shaft 265 (shown in FIG. 5E) to rotate the food surface assembly. The apparatus further includes a control box 80 (shown in FIG. 5A(i)). The control box includes a sub-controller coupled to the drive motor and operative to control the drive motor to control the rate of rotation of the food preparation assembly. The sub-controller can be a conventional motor control card that adheres to the CANOpen specification such as motor control cards available from Elmo Motion Control, Inc. of Westford, Mass.

Thermocouple Slip Ring

With reference to FIGS. 5C, a conventional slip ring assembly 15 (typically used for transmitting power) is used for transmitting temperature measurements from the thermocouple assembly 88 to the sub-controller 80. The system transmits low voltages through the slip ring. The slip ring assembly includes a slip ring 15a, a first slip ring mount 77 and a second slip ring mount 83. A plastic collar 81 helps to keep the slip ring assembly from freezing. If the slip ring assembly gets too cold, moisture from the air can condense on the slip ring assembly either causing the assembly to freeze up or resulting in errant temperature readings. Thus the plastic collar acts as an insulator between the slip ring and the shaft eliminating direct metal-to-metal contact.

The system also uses a conventional seal 20 as a moisture barrier. The seal keeps moisture out of the system and away from the shaft and any housings to prevent moisture from being pulled into the shaft and housings. Moisture in the system, e.g., on the shaft, can freeze and ultimately lock the shaft, i.e., prevent rotation of the shaft.

Rotary Coupling

With reference to FIGS. 5B-5E, food surface assembly 70 contains a fluid path 85. The fluid path 85 has ends that are connected by a rotary coupling 261 to fluid lines leading to and from a primary refrigeration system. The rotary coupling includes an upper seal housing 204 and a lower seal housing 205. The housings are modular housings that hold both support bearings and rotating refrigerant shaft seals. The seals themselves are conventional seals.

The modular design facilitates testing prior to assembly. The FSA does not have to be installed inside the unit (shown as element 200 in FIG. 1) to test for leaks. Having to wait for full assembly to test for leaks means that when a leak occurs the assemblers have to disassemble the unit, a time-consuming task.

More specifically, with reference to FIG. 5E, moving from top to bottom of the figure, the figure shows a drive shaft 265 and a driven gear 78. The upper housing module 204 includes a large bearing 283, a seal retainer plate 278 with a set of screws, a channel 275, another retainer plate 283 and another bearing 283. This configuration is repeated in the lower seal housing 205. This configuration creates a refrigerant passage and seals the passage so that the refrigerant does not escape.

The upper seal housing 204 has an inlet 267 for receiving refrigerant. The refrigerant travels along the center of the shaft 265 via the channel 269 where it is coupled to the freeze surface assembly 70. The refrigerant passes through the serpentine channel milled in the upper freeze plate. The refrigerant exits the freeze surface assembly and travels along the shaft 265 via channel 273 and exits via outlet 271 in the lower seal housing 205.

A mount 281 functions to mount the entire assembly to the primary housing. A second plate 279 with an associated nut and bolt assembly allows adjustment for pitch and yaw to help maintain the physical relationship between the freeze plate and a process box/module that resides above the freeze assembly.

With reference to FIGS. 5B, 5C and 5E, the freeze surface assembly further includes a lower shaft 203 and an upper shaft 210. O-rings 202a provide a face seal between the upper shaft 210 and the inlet 82a and outlet 82b. Similarly O-rings 202b provide a face seal between the lower shaft 203 and the upper shaft 210.

Food Zone Cover

With reference to FIGS. SA, and 6A-6F, one embodiment of a food zone cover apparatus 93 encloses at least a portion of a substantially horizontal, flat rotary surface (the surface is shown in FIG. 5A(ii) as 70a). The illustrated food zone apparatus includes a cover 90 operative to substantially enclose at least a portion of the flat rotary surface to create a food zone. In the illustrated embodiment the shape of the cover 90 mimics at least a portion of the rotary surface, e.g., FIG. 6D(i) shows the shape of the periphery of the cover to include a substantially circular arc 90a, the ends of which are connected by a substantially straight edge 90b. The apparatus includes a final mixing tube interface 92 coupled to the cover 90 and operative to receive liquid via a final mixing tube 92a (shown in FIG. 6B), the final mixing tube operative to deposit a selected amount of liquid product mix on the rotary surface while the rotary surface is rotating so that the liquid product mix spreads out on the rotary surface and sets to form a thin, at least partially solidified, product body. More specifically, a tube assembly couples to the inlet 91 to provide aerated (typically flavored) liquid to the rotary freeze surface below the cover 90.

With reference to FIG. 6B, the apparatus includes a scraper 96 coupled to the cover 90 and supported above the rotary surface. The scraper 96 has a working edge 96a engaging the rotary surface while the rotary surface is rotating to scrape the at least partially solidified product body into a ridge row on the rotary.

The apparatus includes a level 94, e.g., a squeegee, coupled to the cover 90 and spaced above the rotary surface to establish a gap. More specifically, the level has a working edge 94a spaced above the rotary surface to establish a gap between the working edge 94a and the rotary surface. With reference to FIG. 6F, one embodiment of the squeegee includes feet 162a, 162b that maintain a specified gap between the working edge 94a and the rotary surface. The level resides in proximity to the mixing tube outlet 92a such that when the rotary surface rotates in its intended direction the level contacts the food product, e.g., aerated, flavored liquid, before the scraper so as to level the food product to a specified height on the rotary surface while the rotary surface is rotating prior to the formation of the at least partially solidified product. In one embodiment, the gap/spacing between the working edge of the level, e.g., squeegee, and the rotary surface is between about 0.005 and 0.030 inches. In an alternative embodiment, the gap/spacing is between about 0.015 and 0.020 inches.

With reference to FIG. 6C, the apparatus includes a rack and pinion structure 110, 111 coupled to the cover 90. The rack and pinion structure has a rack 110 and pinion 111. The apparatus includes a plow 100 coupled to the rack and operative to scrape the ridge row from the rotary surface as food product. The apparatus includes a forming cylinder 98 coupled to the cover and operative to receive the food product from the plow.

With reference to FIG. 6D(iv), the apparatus includes a diaphragm 160 slidably coupled to the inside of the forming cylinder 98 so as to allow the diaphragm to move longitudinally, i.e., up and down, within the cylinder. Downward movement of the diaphragm after insertion of food product in the forming/dispensing cylinder forms the food product into a scoop. In the illustrated embodiment, the bottom portion of the diaphragm, i.e., the portion of the diaphragm that comes in contact with the food product, is semi-spherical in shape. However, the diaphragm could take other shapes as is obvious to those of ordinary skill in the art. In the illustrated embodiment, the top of the diaphragm has a mushroom shaped structure 97a with a donut shaped cutout 97b below the cap of the mushroom. The donut shaped cutout receives a diaphragm piston to allow movement of the diaphragm from a first retracted position to a second, extended position.

The apparatus includes a packing/cleaning plate 113 rotatably coupled to the cover 90 via shaft 114. The packing plate 113 is positioned below the forming cylinder to provide a food-product packing surface. In operation, a driven rotating piston rotates the packing plate 113 to clear the opening 98a of the forming cylinder 98. Clearing the opening 98a allows the formed/packed ice cream serving to be pushed out of the forming cylinder into a serving cup by longitudinal, i.e., downward, movement of the diaphragm to its extended position.

With reference to FIGS. 6A, 6E, 9A, and 9D, one embodiment of the food zone apparatus 93 interfaces with a process box 230 that includes a set of pistons, e.g., pneumatically driven pistons. In the illustrated embodiment the process box is located above the food surface assembly. More specifically, in operation an operator places the food zone cover apparatus over the rotary surface and the system lowers pistons from the process box to hold the food zone apparatus/cover in place and to operate the elements of the apparatus. Thus, in one embodiment, depending on local health department regulations, periodic (e.g., daily) cleaning under normal circumstances can be limited to a region confined by the food zone cover. When cleaning is required, the process box raises its pistons and an operator can remove the food zone cover to facilitate cleaning of the cover and the freeze surface 70a.

Thus, in one embodiment, the food zone apparatus/cover includes a level pneumatic piston interface assembly 106 coupled to the level 94 and operative to interface with at least one pneumatic piston to allow control of the level. In the illustrated embodiment, the interface assembly 106 includes downforce interface 105 for interfacing with level downforce piston 105a and cleaning interface 103 for interfacing with cleaning piston 103a. The level downforce piston presses on the interface 103 including a level downforce shaft to cause the level to engage with the rotary surface. The cleaning piston 103a engages the level to press the level against the rotary surface for the purpose of cleaning the level to reduce carry over from one serving to another. Carry over occurs when one flavor of food product, e.g., ice cream, used in a first serving contaminates a subsequently created serving. The feet 162a, 162b shown in FIG. 6F are flexible such that with sufficient force the feet bend back and the squeegee presses against the rotary surface for cleaning.

The food zone apparatus includes a pinion pneumatic piston interface 107 coupled to the cover 90 and to the pinion 110a and operative to interface with a pneumatic piston 107a. An electric motor 115 rotates the pinion piston 107a to cause rotation of the pinion 110a and consequently movement of plow 100 attached to rack 111.

As noted above, the apparatus includes a diaphragm pneumatic piston interface 97 coupled to the diaphragm and operative to interface with a pneumatic piston 97a to allow control of the diaphragm to form the food product. The apparatus includes a packing plate pneumatic piston interface 102 coupled to the packing plate shaft and operative to interface with a pneumatic piston 102a. A motor rotates the piston to allow operation of the packing plate.

The apparatus further includes a plurality of features 99, 101 in the cover operative to interface with pneumatic pistons to hold the cover against the rotating surface. More specifically, the depression 99 located on the periphery of the top 90c of cover 90 interfaces with hold down piston 99a. Similarly depression 101, also located on the periphery of the top of cover 90 but, when viewed from above, angularly displaced relative to depression 99, interfaces with hold piston 101a.

With reference to FIG. 6A, the illustrated food zone apparatus further includes a mix-ins receiving port 108 coupled to the cover. The port 108 receives mix-ins from the dispensing hole of the mix-ins trough and distributes the mix-ins onto the liquid product after the level has leveled the liquid food product onto the rotary freeze surface.

Flavor Selection Assembly/Flavor Wheel

With reference to FIGS. 7A-7E, one embodiment of a flavor selection assembly 208 includes a pump motor 210 connected to a pulley assembly 212. The pulley assembly includes a driving gear 212c coupled by a belt 212b to a driven gear 212a. The driven gear in turn couples via shaft 214a to a flavor distribution wheel (FDW) assembly 214. The FDW assembly includes a wheel 214c with a plurality of fittings 214b which form a plurality of nozzles 216a, 216b. In the illustrated embodiment there are twelve nozzles, each nozzle adapted to connect via tubing to an associated displacement pump in the flavor module described above. The FDW assembly further includes an outlet 218 that couples to a common flavoring outlet tube. With reference to FIGS. 7A-7C, the center 215 of the flavor wheel 214c has a channel 211 (shown in 7B).

The flavor wheel assembly 208 further includes a sub-controller 209 and a conventional sensor 213 coupled to the sub-controller. The sub-controller receives signals from the sensor and controls motor 210 to position the flavor wheel in a home position, e.g., rotating the flavor wheel to align the channel 211 so that it is between two nozzles (such as 216a and 216b). In this position no flavor can pass through to the outlet 218.

In operation, each flavor enters the flavor wheel via one of the plurality of nozzles 216a, 216b. When the system receives a flavor selection signal, the main controller instructs the flavor wheel sub-controller 209, via bus 209a, to drive the motor 210 to rotate the channel 211 a specified amount to bring the channel 211 into alignment with the nozzle associated with the selected flavor thereby allowing the flavor in the aligned nozzle to flow through to outlet 218.

A fitting 217 also sits on top of the shaft 214a to receive compressed air for cleaning out the outlet 118 and the outlet tube. As shown in FIG. 9A, in one embodiment the flavor wheel assembly 208 resides in a process box 230 that sits above the food zone cover apparatus and the food preparation assembly (shown in FIG. 1 as element 22).

Tube Kit

With reference to FIGS. 2B and 8, one embodiment of a tube kit 120 includes a proximal end 120a and a distal end 120b. The proximal end includes a crow's foot junction 122 having 3 inlets and an outlet 122a. The first inlet 121 couples to a tube not shown that in turn connects to the tube 32 via the bulkhead tube-to-tube union 33. In other words, the first inlet receives a first base mix via a tube line attached to a first base mix container held in a first base mix tray 30a in the base mix module. Similarly, the third inlet 125 receives a second base mix via a tube line attached to a second base mix container held in the second base mix tray 30b in the base mix module. The second inlet 123 couples via a one-way valve 129 and via tubing to a pneumatic module (shown in FIG. 9E) for receiving air. The crow's foot junction 122 couples via a female luer lock 141 to tubing 120c.

The tube kit's distal end 120b includes a barbed rotating male luer lock adaptor 139 coupled to the distal end of tubing 120c. The adaptor 139 couples to a female luer lock 131. The lock 131 couples to a first inlet of a two-inlet, one-outlet tee connection 137. The second inlet couples via a male luer lock 135 to food grade tubing 133, which in turn couples to the output of the flavor selection assembly of FIGS. 7A-7E. The outlet of the tee connection 137 couples via tubing 136 to mixing tube 127. This configuration allows the tube kit to combine base mix, air and flavoring to produce a flavored, aerated mix at the output of mixing tube 127. In one embodiment, flavored aerated mix is ejected from a distal end of the mixing tube 127 onto the rotating freeze surface 70a of the FSA shown in FIGS. 5A to 5C. More specifically, with reference to FIGS. 6A and 6B, the tube kit couples to the food zone cover apparatus 93 and sprays the mix from end 92a onto the rotating freeze surface. Element 92 shown in FIG. 6A is the same as the mixing tube 127 shown in FIG. 8.

Process Box

With reference to FIGS. 9A-9H, one embodiment of the process box 230 includes a conventional electrically operated pneumatic solenoid pump bank 232 (shown in FIGS. 9B and 9C) such as those available form SMC Corporation of America of Indianapolis, Ind. In one embodiment, the pump bank 232 includes an air inlet 231 and a plurality of, e.g., seven, air outlets 233a, 233b. The air input couples to a conventional pneumatic module 242 such as a Gast compressor systems available from Ohlheiser Corporation of Newington, Conn. Pneumatic module provides regulated compressed air, e.g., at about 80 psi, to the air inlet of the pump bank.

As noted above with respect to the food zone apparatus, the process box further includes a plurality of, e.g., seven, pneumatically driven piston assemblies 97b, 99b, 101b, 102b, 103b, 105b, 107b. Each assembly has a piston 97a, 99a, 101a, 102a, 103a, 105a, 107a coupled to a pneumatic cylinder 97c, 99c, 101c, 102c, 103c, 105c, 107c. Each pneumatic cylinder couples to an air output of the solenoid bank. The solenoid bank distributes air pressure to the pneumatic cylinders to operate the piston assemblies. Each piston 97a, 99a, 101a, 102a, 103a, 105a, 107a interacts with an associated piston interface 97, 99, 101, 102, 103, 105, 107 on the food zone cover. As noted above, a conventional pneumatic module couples to the air inlet of the solenoid bank and provides compressed air to the solenoid bank so that the solenoid bank can manage operation of the piston assemblies to control interaction of the pistons with associated piston interfaces on the food zone cover.

With reference to FIG. 9E, the pneumatic module 242 includes a holding tank 246 that provides food grade air to an air compressor 244. The air compressor in turn provides compressed air to a first regulator 248 and a second regulator 250. The first regulator provides regulated air at a specified pressure, e.g., 80 psi, to the pump bank in the process box. The second regulator provides food grade air at a specified pressure, e.g., 40 psi, to the tube kit.

Packing Plate Piston Assembly

Having described the process box in general, with reference to FIG. 9F, one embodiment of a packing plate piston assembly 102b located in the process box includes a post 274 coupled to a base 276. The post couples to a proximal end of an arm 268 via a pin 270. A cylinder 102c couples to the base 276 and to a midsection of the arm so as to raise and lower the arm. A distal end of the arm couples to a piston shaft 266 via a shaft end 272. Thus, actuating the cylinder lowers the shaft. A gear 264 slides onto the shaft and affixes to the shaft in a concentric arrangement. The assembly further includes a motor 260, which drives a pinion 262. The driven pinion in turn drives the gear 264 to rotate the piston shaft.

Thus, with reference to FIGS. 9F and 6A, in operation the process box sub-controller actuates the cylinder 102c to lower the piston shaft 266, which engages piston 102a with piston interface 102. The process box sub-controller then energizes motor 260 to rotate the piston shaft 266, which in turn rotates packing plate 113 to operate the packing plate.

Packing Piston Drive Assembly

With reference to FIG. 9G, one embodiment of a packing piston drive assembly 97b located in the process box includes a cylinder 97c mounted on a bracket 284, which in turn is mounted on a bottom plate 286. The assembly also includes a piston guide 288 that also mounts on the plate 286 so as to cover hole 292. A top plate 290 attaches to cylinder 97c and guide 288. The packing piston 97a slidably engages with the bottom plate 286 and with guide 288 via hole 292. Attached to the cylinder is a sliding cylinder plate 280. Attached to the cylinder plate is piston attachment plate 282, which also attaches to piston 97a. Thus, when the process box sub-controller actuates the cylinder, the cylinder drives the piston down to interact with interface 97 to operate the diaphragm (described above with respect to the food cover). In one embodiment a pin (element 290 shown in FIG. 9B(i)) engages with slot 97b (shown in FIG. 6D(iv)).

Rack and Pinion Drive Assembly

With reference to FIG. 9H, one embodiment of a rack and pinion drive assembly 107b located in the process box includes a post 294 coupled to a base 296. The post couples to a proximal end of an arm 298 via a pin 297. A cylinder 107c couples to the base 296 and to a mid-section of the arm so as to raise and lower the arm. A distal end of the arm couples to a piston shaft 107a via a shaft end 295. Actuating the cylinder lowers the piston shaft. A gear 291 slides onto the shaft and affixes to the shaft in a concentric arrangement. The assembly further includes a motor 289, which drives a pinion 293. The driven pinion in turn drives the gear 291 to rotate the piston shaft.

Thus, with reference to FIGS. 9H and 6B(i), in operation the process box sub-controller actuates the cylinder 107c to lower the piston shaft 107a, which engages with piston interface 107. The process box sub-controller then energizes motor 289 to rotate the piston shaft 107a, which in turn rotates the pinion 110a to operate the plow 100 (pinion 110a and plow 100 are shown in FIG. 6C).

The other four piston assemblies, i.e., 99b, 101b, 103b, 105b, are, for example, conventional piston assemblies.

Primary Refrigeration System (PRS)

With reference to FIG. 10A, one can describe the architecture of one embodiment of the primary refrigeration system (PRS) 300 for the FSA by describing the loop(s) through which refrigerant travels during various modes of operation of the PRS.

Cooling

During cooling, i.e., when the PRS brings the table 318 down from ambient temperature to a set point, a cooling loop starts with refrigerant gas flowing from a compressor 326 via a compressor discharge line 306 to a condenser 302. Stated differently, the compressor discharges refrigerant in the form of relatively hot and high-pressure gas. The compressor discharges the refrigerant into the condenser. A fan blows ambient air over the condenser transferring heat in the gas to the ambient air; the fan blows the ambient air out of the unit. By cooling the hot gas, the PRS changes the hot gas into a warm liquid. Under normal operation, the PRS keeps a defrost solenoid 310 (an alternate loop) closed and all of the refrigerant goes through the condenser.

The liquid flows from the condenser into a receiver 304, which stores liquid for the refrigeration system. The liquid flows through a filter drier 308, which removes particulates, acid and moisture from the refrigerant. Then the liquid flows through a coil situated in the bottom of the suction accumulator 324. The warm liquid in the coil boils off any liquid coming into the suction accumulator via a suction line 323.

The liquid flows through a liquid solenoid, which provides on/off control to a liquid thermal expansion (TX) stepper valve 312. The main controller using a control algorithm with a wet/dry thermistor 326 as an input, controls the liquid flow into the table 316. As noted above, the main controller communicates via a bus to sub-controllers using a protocol such as the CANOpen protocol. In one embodiment, the PRS sub-controller includes digital I/O board with a CANOpen gateway and two analog I/O boards. The sub-controller further includes first and second stepper controller boards daisy-chained to the digital I/O board.

The liquid control feeds an excess of liquid into the table 316, which keeps the wet/dry thermistor at the table exit wet, i.e., the refrigerant passing the thermistor is at least partially in a liquid state. As the liquid refrigerant passes through the table, it boils, cooling the table. More specifically, when the refrigerant passes through the expansion valve 312, the refrigerant experiences a pressure drop that turns the liquid into a cold liquid with some gas. The system injects the refrigerant in this state into the table 318 where the cold liquid chills the table. In the process of cooling the table, much of the liquid boils off into a gas. The liquid and gas mixture leaves the table and passes through the suction accumulator. The excess liquid collects in the bottom of the accumulator where it is boiled by the warm liquid coil. The refrigerant gas leaves the accumulator and returns to the compressor.

More specifically, the liquid stepper valve is a conventional electronically controlled needle valve. The liquid stepper valve passes the liquid refrigerant, via a liquid stepper discharge line 313 and via a rotary coupling 314a, into the freeze plate 316. A thermal couple 318 facilitates measurement of the table temperature. The refrigerant then exits the plate 316 via rotary coupling 314b and travels back to the suction accumulator 324 via a table discharge line 321. In the illustrated embodiment, the discharge line 321 has a serpentine section 325 having a length of about 8 feet or more with a plurality of turns, e.g., four to eight bends. A pressure transducer 320 measures the pressure just prior, i.e., just upstream, to the serpentine section 325. The thermistor 326, mentioned above, measures the temperature in the discharge line on the downstream side of the serpentine section 325. In one embodiment, the PRS uses a conventional refrigerant such as R404A. However, the PRS can use other refrigerants such as R507.

After a period of time, the table temperature sensor 318 measures that the table has reached a set point. At this point the system also utilizes a temperature control loop.

Temperature Control

In order to artificially reduce the cooling capacity of the cooling loop (to maintain the set point temperature), the system introduces a false load. Thus, with reference to FIG. 10B, when the system uses a temperature control loop, in addition to running the cooling loop (shown as loop 1), the system diverts (via loop 2) hot gas from the compressor discharge line through a hot gas solenoid. The hot gas then travels through a hot gas stepper 322 (a proportionally controlled valve) and enters the cooling loop (loop 1) at a point 323 proximate to the beginning of the serpentine section 325. In the illustrated embodiment the hot gas from the hot gas valve enters the table discharge line downstream from the location of the pressure transducer 320. The hot gas stepper valve controls the amount of hot gas that passes into the table discharge line 321.

A hot gas valve control scheme controls on temperature. If the table temperature as measured by sensor 318 is below the set point, the control scheme opens the hot gas valve by an amount that is proportional to how far the table temperature is below the set point and proportional to how long the table temperature has been below the set point. The control scheme utilizes a Proportional Integral and Derivative (PID) loop. Thus, the temperature control loop (loop 2) applies a false load to the compressor reducing the capacity of the cooling loop to cool the table.

Modes/Control States

Pull Down

The primary refrigeration system (PRS) control scheme includes a variety of modes. In pull down mode, the mode in which the table temperature is brought down from ambient temperature to a set point, the system brings the table temperature to the temperature that is needed to make ice cream. In one embodiment, the goal for pull down mode is to achieve the set point temperature, e.g., 12 degrees Fahrenheit, to within plus or minus one degree for 30 seconds. The pull down modes starts with the hot gas valve in the off position, the liquid valve is at a boosted set point, e.g., about 280 steps where the valve ranges from 0 to 380 steps (380 steps being completely open). Once the system is within a specified range, e.g., within 10 degrees, of the set point temperature, the system sets the liquid valve to a normal set value, e.g., 135 steps.

Idle/Standby

Once the system achieves the set point to within plus or minus one degree for 30 seconds, the system transitions from pull down mode to idle mode. Idle mode is a mode in which the system is ready to make food product, e.g., ice cream. Once the system starts spraying liquid onto the freeze surface assembly, within less than a ten second interval, the PRS sees a large heat load because the PRS changes the state of the sprayed material from a liquid (mostly water) to an at least partially frozen food product, e.g., ice cream. In other words, in one embodiment the PRS freezes a serving's worth of water, which involves a change of state of the water requiring a large amount of energy in a very short period of time relative to maintaining the plate's temperature in an idle state.

Once in Idle mode, the control scheme no longer controls the system based on a direct measurement of the table temperature. Rather the control scheme controls based on readings from the pressure transducer.

The pressure transducer is used to determine the refrigerant temperature in the table. The refrigerant for any given pressure only boils at one temperature. So if one measures the pressure in the table discharge line, then one can determine the temperature of the refrigerant. Pressure/temperature curves for various refrigerants, such as R404A and R507, are known by those of ordinary skill in the art. The control scheme controls the hot gas valve based on readings from the pressure transducer rather than on readings from the sensor 318 because of the sensitivity of the table temperature to the food product when food product is placed on the table during an ice cream making mode.

The control scheme is self-correcting. Once the PRS transitions into idle mode, the system determines saturation temperature, the boiling temperature of the refrigerant, based on the first pressure transducer measurement of pressure. The system then uses that saturation temperature as a set point.

The system controls transition from pull down mode to idle mode and controls the hot gas valve 322 in idle mode in an effort to directly control the table temperature. In contrast, the control scheme controls the liquid TX stepper valve 312 so that the thermistor 326 indicates that the refrigerant is in a wet state, i.e., the refrigerant passing the thermistor is at least partially in a liquid state.

In one embodiment, the system floods the table so that the system has excess liquid at the exit from the table. Flooding the table ensures that the table is fully active with refrigerant boiling across the whole table. To achieve a flooded table, the control scheme uses the thermistor 326 to monitor the state of the refrigerant.

More specifically, in order to maintain the refrigerant in a wet state, the control scheme measures resistance across the thermistor periodically, e.g., every thirty seconds, and controls the liquid valve in response to those measurements. The thermistor is a a type of resistor used to measure temperature changes, relying on the change in its resistance with changing temperature.

If one assumes that the relationship between resistance and temperature is linear, then one can state the following:
ΔR=kΔT
where
ΔR=change in resistance
ΔT=change in temperature
k=first-order temperature coefficient of resistance

When the refrigerant transitions from a dry state to a wet state, it becomes colder. Assuming k is positive, when the temperature of the refrigerant becomes colder the resistance measured by the thermistor drops. Assuming a constant current source, a drop in thermistor resistance results in a voltage drop across the thermistor. In one embodiment, a refrigerant dry state is defined as corresponding to a 5-volt drop, and a refrigerant wet state is defined as corresponding to a 2-3 volt drop. Thus, the control scheme monitors the thermistor periodically, e.g., every 30 seconds, and if the thermistor voltage drop does not indicate a wet state, the control scheme adjusts the liquid stepper valve in an attempt to return the refrigerant to a wet state.

Stated differently, the system uses the liquid stepper valve to control the quantity of liquid at the wet/dry thermistor to keep the table flooded. When the liquid stepper valve opens up it increases the quantity of refrigerant in the system, which in turn raises the pressure in the table discharge line measured by the pressure transducer, which in turn changes the temperature, which causes the hot gas valve to react. Thus, the liquid stepper valve and hot gas valve systems are interdependent.

When a system designer designs a typical refrigerant system, generally the designer does not care much about where the position of liquid refrigerant is in the system, other than not wanting it in the compressor. Other than that, all a designer is typically trying to do is to maintain some temperature in some environment.

In the present invention, it is helpful to maintain the plate in a flooded state. In other words, in one embodiment, the system attempts to ensure that at least some refrigerant remains in liquid state during the refrigerant's path through the serpentine channel in the freeze plate assembly (FPA).

When a temperature change of a liquid, e.g., refrigerant, involves boiling, i.e., the state transition of a liquid to a gas, the temperature change involves a large energy transfer relative to a similar temperature change not involving a state transition. By maintaining a liquid state, the system maintains the ability to have a relatively large influence on the temperature of the FPA in a relatively short amount of time.

In addition, maintaining a flooded state helps maintain temperature stability across the entire freeze plate (one embodiment of the freeze plate has a 19 inch diameter), and it provides the system with relatively precise control of the temperature because the system does not need to adjust for the possibility that the refrigerant might turn completely to gas in the evaporator/freeze surface assembly; the refrigerant is always in an at least partially liquid state. In one embodiment, the PRS controls the temperature to ±1 degree Fahrenheit (F) and maintains uniformity of the temperature across the freeze surface to within ±1 F.

As noted above, when the system first enters pull down mode, the system sets the liquid valve at a boosted set value, e.g., 280 steps in a range of 0-380 steps. Once the system is within a specified range, e.g., within 10 degrees, of the set point temperature, the system sets the liquid valve to a normal set value, e.g., 135 steps. Once the system transitions into idle mode, the system adjusts the liquid valve setting to maintain the refrigerant at the thermistor in a wet state.

Making Ice Cream

When the system is in idle mode it is ready to make ice cream. With reference to FIG. 10F, at state 0, a user indicates via user controls, e.g., a graphical user interface, that the user wants the unit to make a selected ice cream serving. In response, after a predetermined amount of time and before the system sprays food product onto the freeze table, the main controller enters a pre-cold stage, state 1. The food product is only on the freeze plate for about ten seconds. At state 1 the main controller shuts down the hot gas valve and sets the liquid valve to the boosted set value, e.g., about 280 steps. At state 2 the system sprays the food product onto the freeze table. At state 3, the food product, now in the form of frozen food product, e.g., ice cream, leaves the table.

Once the food product leaves the table, the system monitors the table temperature. The system transitions to the next state, state 4, once the table temperature is below the table temperature set point, e.g., 12 degrees. If the table temperature is below the set point when the food product comes off the table then the system automatically transitions to state 4. Otherwise, the system waits until the table temperature is below the set point to make the transition. The system polls the table temperature periodically, e.g., every 100 ms±30 ms, to determine when to make transitions that depend on table temperature. At the transition, the system opens the hot gas valve to the value it had at state 0, the state 0 value. It takes a predetermined amount of time for the hot gas valve to achieve the state 0 value. When the hot gas valve achieves the state 0 value, the system transitions to state 5.

The system transitions to the next state, state 6, when the controller determines, by monitoring the pressure transducer, that the saturation temperature has recovered (e.g., when the saturation temperature is greater than or equal to the original saturation temperature set point plus some predetermined amount). Once the system transitions to state 6, the system returns the liquid valve to the value it had at state 0, the state 0 value or normal set point value (e.g., about 130 steps). As with the hot gas valve, it takes a predetermined amount of time for the liquid valve to achieve the normal set point value.

As noted above, the main controller communicates with sub-controllers including the PRS sub-controller using a protocol such as the CANOpen protocol. One can refer to each sub-controller or module with which CANOpen communicates as a node. There are stepper controllers for the hot gas valve and for the liquid TX valve. There are different processes running on the host computer which will communicate with and/or direct each node.

In one embodiment, the program that controls the main controller is written in the C programming language and follows the CANOpen specification to achieve communication with sub-controllers including the PRS sub-controller.

Defrost Loop/Mode

With reference to FIG. 10C, the defrost loop includes a refrigerant gas flowing from the compressor 326 through the discharge line 306 to the defrost solenoid 310. The defrost solenoid couples the compressor discharge line 306 with the liquid stepper discharge line 313. The defrost mode thaws the table out. In other words, in defrost mode the system raises the table temperature so that the table can be cleaned. During defrost mode, the main controller closes the liquid solenoid and the hot gas solenoid so there is no flow down the cooling loop and the temperature control loop. The defrost solenoid is open and refrigerant gas, which is hot from the compressor, is directed into the table. The hot refrigerant gas returns through the suction line 323 and through the suction accumulator back to the compressor. Thus, the defrost loop provides a loop of warm gas that flows through the table warming the table to a defrost set point temperature. Over a period of time, e.g., three to five minutes, the table warms up, when the table sensor 318 determines that the table has reached a set point, e.g., 48 degrees Fahrenheit, the main controller terminates defrost mode and turns the defrost solenoid off. Once the freeze plate portion of the food preparation assembly has reached the defrost set point temperature, an operator can then clean the freeze plate and associated areas, e.g., the operator can wipe down the freeze plate. Cleaning of the freeze plate and associated areas can also be automated.

Depending on requirements of the user of a system according to the invention, the user can instruct the system via user controls, e.g., a graphical user interface, to enter the defrost mode periodically, e.g., once a day typically at the end of the day.

Controls

With reference to FIG. 10D, the PRS includes a hot gas valve control 328 for controlling the table temperature. As noted above, the control monitors the table surface temperature via thermocouple 318 and the suction pressure via pressure transducer 320.

With reference to FIG. 10E, the PRS includes a liquid stepper control 330 for controlling the flow of liquid refrigerant into the table 316. As noted above, the control 330 monitors the thermistor 326 and opens and closes the stepper valve to keep the thermistor in what is referred to as a “wet zone.”

Control States

In one embodiment, the control states for the PRS are the following: Initialization; Stopped; Pull down (startup); Standby; Ice Cream cycle (7 steps); Defrost; Fault; and Override/Diagnostics.

Control state Initialization is the process of turning the machine on. Control state Stopped involves stopping the PRS. Pull down occurs when the freeze surface assembly (FSA) is above the set point temperature, e.g., at ambient temperature, and the PRS pulls the FSA down to the set point. In one embodiment, the pull down process from room temperature takes about twenty minutes.

The PRS system uses conventional Proportional Integral and Derivative (PID) control.

PID is a form of control appropriate for a system that cannot move from a given environmental condition to the set point simply as a step function. In other words, PID control is a form of control appropriate for a PRS that cannot move the FSA from 85 degrees Fahrenheit (F) linearly and directly to 12 F. PID control typically achieves a set point via a sinusoidal closed wave function. A PRS system using PID control and having a 12 F set point starts with the FSA at ambient temperature, e.g., 85 F. The FSA temperature starts coming down. The FSA temperature passes below the set point, e.g., 12 F. The FSA temperature then oscillates up and down around the set point. Thus, the temperature of the FSA as a function of time resembles a dampened harmonic oscillator oscillating around the set point temperature. The amplitude of the oscillations becomes smaller and smaller and eventually the wave dampens itself out.

The Idle/Standby, Ice Cream Cycle/Making, and Defrost states/modes were described above. The other states are conventional states used in controlling food preparation machines.

With reference to FIG. 10G, many of the elements of the primary refrigeration system (PRS) are conventional. The following is a list of parts and associated manufacturers and suppliers for one embodiment of the PRS.

| | | | | Supplied | DCI | Lydall |
|---|---|---|---|---|---|---|
| Item | Description | Manufacturer | Part number | By | Part # | Part # |
| 1 | Condensing | Tecumseh | AWA2464ZXDXC | DCI | 61872 | |
| | Unit | | | | | |
| 2 | Filter drier | Sporlan | C-083-S | Lydall | 61872 | 9476 |
| 3 | Sight glass | Sporlan | SA13S | Lydall | 68119 | 2546 |
| 4 | TX value | Emerson Flow | ESVB-1 24 | DCI | 61873 | |
| | | Control | | | | |
| 5 | Hot gas value | Sporlan | SEI 11 3X4 ODF- | Lydall | 72525 | 13072 |
| | | | 10-S | | | |
| 7 | Suction | Refrigeration | HX 3738 | Lydall | 72529 | 32660 |
| | accumulator | Research | | | | |
| 8 | Thermistor | Parker | 040935-04 | DCI | 72539 | |
| | Adapter ⅞ | | | | | |
| 9 | Thermistor | Parker | 040930-150 | DCI | 72537 | |
| 10 | Solenoid value | Sporlan | E5S130 | Lydall | | 33101 |
| | 1 - Defrost | | | | | |
| 11 | ⅝ Ball value | Various | | Lydall | 72890 | 6095 |
| | refrigeration | | | | | |
| | grade | | | | | |
| 12 | ⅞ Ball vale | Various | A17264 | Lydall | 74004 | 6096 |
| | refrigeration | | | | | |
| | grade | | | | | |
| 13 | ⅝ tube fitting | Parker | 12-10L0HB3-S | DCI | 72639 | |
| 14 | Connector, | Alco | 62093 | DCI | 61874 | |
| | stepper, 4 wire | | | | | |
| | for TX | | | | | |
| 15 | Tube fitting | Parker | | DCI | | |
| 16 | Liquid hose | Parker | 73499 | DCI | 73499 | |
| 17 | Suction hose | Parker | 73501 | DCI | 73501 | |
| 18 | Suction line | Lydall | 32722 | Lydall | 74013 | 32722 |
| | mixing line ⅞ | | | | | |
| 19 | Suction riser | Lydall | 32724 | Lydall | 74012 | 32724 |
| | ⅞ | | | | | |
| 20 | Suction line | Lydall | 32723 | Lydall | 74009 | 32723 |
| | ⅞ | | | | | |
| 22 | Pressure | MSI | MSP-300-250-P-4-N-1 | DCI | 73021 | |
| | transducer | | | | | |
| 23 | Refrigerant | | | Lydall | 74016 | 28124 |
| | R404a | | | | | |
| 24 | Solenoid value | Sporlan | B6S1 | Lydall | | 33102 |
| | 2-Hot gas | | 1/2ODFx5/8ODM | | | |
| 25 | Solenoid value | Sporlan | E5S130 | Lydall | | 33101 |
| | 3-Liquid | | | | | |
| 26 | Solenoid coil | Sporlan | MKC1-208- | DCI | 74169 | |
| | | | 240/50-60 | | | |
| 27 | Pressure switch | Emerson Flow | PS1-X5K | Lydall | | 5704 |
| | | Control | | | | |

DCI is DCI Automation, Inc. of Worcester, Mass. Lydall is Lydall, Inc. of Manchester, Conn. Tecumseh is Tecumseh Products Company of Tecumseh, Mich. Sporlan is Sporlan Valve Company of Washington, Miss. Parker is the climate and industrial controls group of Parker Hannifin Corporation located in Broadview, Ill. Emerson Flow Control is the flow controls division of Emerson Climate Technologies of St. Louis, Miss. Refrigeration Research is Refrigeration Research, Inc. of Brighton, Mich.

Timing Diagrams

Having provided an overview of the structure and operation of the unit 200 shown in FIG. 1 and having described the structure and operation of the components that make up that unit, a description of timing diagrams for various system sequences is now provided. Each of the timing diagrams lists the following items (and operational state) on the vertical (y) axis: 1^{st} cover hold-down (up/down); 2^{nd} cover hold-down (up/down); packing plate engagement (up/down); packing plate position (delivery/forming/home); pinion engagement (up/down); horizontal pinion drive (forward/back/home); vertical forming piston (up/neutral/down); cup lift (up/neutral/down); leveling squeegee cleaning (up/down); leveling squeegee downforce (up/down); base pump (running/stopped); aeration (on/off); flavor pump (running/stopped); flavor purge (on/off); and mix-in motor (running/stopped). The horizontal (x) axis denotes time. Thus, the timing diagrams indicate the time of state transitions during various system activities for the items listed on the vertical axis.

The items 1^{st} cover hold-down, 2^{nd} cover hold-down, packing plate engagement, packing plate position, pinion engagement, horizontal pinion drive, vertical forming piston, cup lift, leveling squeegee cleaning, and leveling squeegee downforce refer to the up/down or engagement state of the pistons shown in FIGS. 9A-9D and 9F-9H. The main controller via the process sub-controller controls the pump bank and piston assembly motors to achieve the desired states. Similarly, base pump, aeration, flavor pump, flavor purge, and mix-in motor refer on/off or running/stopped states of the base pump, the food grade portion of the pneumatic module, the flavor pump, the flavor purge portion of the pneumatic module, and the mix-ins motor, respectively. The main controller either directly and/or via various component sub-controllers controls the states of these components.

With reference to FIG. 1 IA, one embodiment a sequence for serving food product, e.g., ice cream, starts in the following state: 1^{st} cover hold-down (down); 2^{nd} cover hold-down (down); packing plate engagement (down); packing plate position (forming); pinion engagement (down); horizontal pinion drive (back); vertical forming piston (up); cup lift (down); leveling squeegee cleaning (up); leveling squeegee downforce (up); base pump (stopped); aeration (off); flavor pump (stopped); flavor purge (off); and mix-in motor (stopped). A variety of conventional sensors determine that the FSM proceeds through the following process prior to initiating the serving sequence: delivery door interlock (disengaged); delivery door sensor (open); user installs cup; cup sensor (yes); delivery door sensor (closed); deliver door interlock (engage); start freeze surface rotation.

The illustrated serving sequence is the following, each numbered step occurring later in time than the prior numbered step: 1) at time TS2 the leveling squeegee moves down; 2) the base pump starts running and the aeration is turned on; 3) the flavor pump starts running(at this point the mixing tube is spraying mixed, aerated (typically flavored mix onto the rotating freeze surface); 4) the mix-in motor starts running (causing the mix-ins module to deposit selected mix-ins onto leveled food product sitting on the rotating freeze surface); 5) the base pump stops; 6) the flavor pump stops and the flavor purge is turned on; 7) the flavor purge ends and the aeration ends; 8) the mix-in motor stops; 9) the leveling squeegee downforce piston disengages (moves up); 10) the leveling squeegee cleaning piston moves down to cause cleaning of the squeegee; 11) leveling squeegee cleaning piston moves up, the cup lift moves up, and the freeze surface stops rotating (the food product is now accumulated as a ridge row on the scraper of the food zone cover); 12) the horizontal pinion drive moves to the forward position (pushing the food product into the forming cylinder); 13) the vertical forming piston moves down (to pack the food product); 14) the vertical forming piston moves to a neutral position; 15) the packing plate position moves from forming to delivery; 16) the product deposits into a cup; 17) the cup lift moves from up to neutral position; 1) the packing plate position moves from delivery to forming; and 19) A variety of conventional sensors determine that the FSM proceeds through the following process: delivery door interlock (disengage); delivery door sensor (open); user removes cup; cup sensor (clear/no cup); delivery door sensor (close); and delivery door interlock (engaged). The serving sequence completes with the following steps: 20) the packing plate position moves from forming to home and then to delivery to achieve a wiping action and the vertical forming piston moves from down to up; 21) the horizontal pinion drive moves from forward to home and then, after a period, to back position; 22) the vertical forming piston moves from up to down and then, after a period, to up position again; 23) Finally, the packing plate position moves from delivery to forming.

This invention relates to systems and methods for producing and dispensing aerated and/or blended products, such as food products. While the invention may be used to produce a variety of products, it has particular application to the production and dispensing of frozen confections such as ice cream and frozen yogurt. Consequently, the invention is described in that context. It should be understood, however, that various aspects of the invention to be described also have application to the making and dispensing of various other food products.

Having thus described at least one illustrative embodiment of the invention, various alterations, modifications and improvements are contemplated by the invention. Such alterations, modifications and improvements are intended to be within the scope and spirit of the invention. Accordingly, the foregoing description is by way of example only and is not intended as limiting. The invention's limit is defined only in the following claims and the equivalents thereto.

What is claimed is:

1. Apparatus for producing a food product, the apparatus comprising:
a frame;
a first module coupled to the frame and operative to provide a first food product,
a second module coupled to the frame and operative to provide a second food product,
a selection assembly coupled to the frame and having an outlet and a plurality of inlets, each inlet operative to receive a portion of the second food product, the selection assembly operative to allow passage of the portion of the second food assembly from an inlet to the outlet;
a tube kit having a proximal end including a first opening coupled to the first module and a second opening for receiving air, the tube kit having a distal end coupled to the outlet of the selection assembly, the tube kit operative to combine the first food product, air and the portion of the second food product to produce a product mix; and
a food preparation assembly coupled to the frame and adapted to receive the product mix from the tube kit and to prepare food from the product mix.

2. The apparatus of claim 1 further comprising an apparatus controller in communication with the first module, the second module, the third module, and the food preparation assembly and configured to operate the apparatus.

3. The apparatus of claim 1 wherein the first module further comprises a-first module sub-controller configured to operate the first module.

4. The apparatus of claim 1 wherein the second module further comprises a second module sub-controller configured to operate the second module.

5. The apparatus of claim 1 wherein the selection assembly further comprises a selection assembly module sub-controller configured to operate the selection assembly.

6. The apparatus of claim 1 wherein the food preparation assembly further comprises a food preparation assembly sub-controller configured to operate the food preparation assembly.

7. The apparatus of claim 1 wherein the first module comprises a base mix module to provide a base mix food product.

8. The apparatus of claim 7 wherein the second module comprises a flavor module configured to provide a flavoring to the base mix.

9. A module for providing a food product, comprising:
a food product holding bay;
a tube assembly having a proximal end and a distal end, the proximal end being coupled to the holding bay;
a pump coupled to the tube assembly;
a source of compressed air coupled to the tube assembly, the source of compressed air having an air control valve operative to control the amount of air provided to the tube assembly; and
a module sub-controller coupled to the pump and operative to control the pump and the air control valve and configured to control the amount of food product and the amount of air injected into the tube assembly.

10. The module of claim 9 wherein the module sub-controller is further configured to hold a temperature of the food product to within a specified temperature range.

11. The module of claim 10 wherein the module sub-controller is configured to hold the temperature of the food product at or below 41 degrees.

12. A flavor module comprising:
at least one flavor packet holding bay operative to hold a flavor packet;
a positive displacement pump coupled to the at least one holding bay and operative to receive flavoring from flavor packets held in the holding bays; and
an electrical solenoid coupled to a slidable support plate, each solenoid operative to engage with the displacement pump to cause the displacement pump to dispense flavoring.

13. The flavor module of claim 12 further comprising a linear drive motor, the linear drive coupled to the slidable support plate.

14. The flavor module of claim 12 further comprising a flavor module sub-controller in communication with each of the solenoids and the linear drive motor, the sub-controller operative to control each of the solenoids and the linear drive motor so as to select and energize a solenoid and to operate the linear drive motor to drive the slidable support plate moving the solenoids relative to the displacement pumps such that the energized solenoid causes an associated displacement pump to dispense flavoring.

15. A food product module comprising:
a plurality of food product assemblies;
a trough assembly having a collection slot and a dispensing opening, the collection slot being coupled to the plurality of assemblies, the trough assembly operative to receive food products from the plurality of assemblies and to dispense the food products; and
a module sub-controller in communication with each of the plurality of food product assemblies, the sub-controller operative to control the plurality of food product assemblies to dispense the food products.

16. The food product module of claim 15 wherein the plurality of food product assemblies further comprises:
an auger block forming:
a storage bottle hole adapted to receive a food product storage bottle; an auger passage connected to the bottle hole; and a dispensing hole connected to the auger passage; and
an auger adapted to sit in the auger passage of the auger block, the auger having an engagable end; and
a plurality of drive assemblies coupled to the engagable end of the augers and operative to drive the augers.

17. The food product module of claim 16 wherein the sub-controller drives the engagable ends to turn the augers to dispense the food products when the bottle is loaded into the food product module.

18. The food product module of claim 15 wherein the food products include at least one of a mix-in or a dry goods food product.

19. A process box comprising:
an electrically operated pneumatic solenoid bank having an air input and a plurality of air outputs;
a plurality of pneumatically driven piston assemblies, each assembly having a piston coupled to a pneumatic cylinder, each pneumatic cylinder coupled to an air output of the solenoid bank, the solenoid bank operative to control air pressure in each pneumatic cylinder, each piston adapted to interact with an associated piston interface on a food zone cover; and
an air compressor coupled to the air input of the solenoid bank and operative to provide compressed air to the air input of the solenoid bank so that the solenoid bank can manage operation of the piston assemblies to control interaction of the pistons with associated piston interfaces on the food zone cover.
